(19) United States
(12) Patent Application Publication
(10) Pub. No.: US 2013/0121631 A1
(43) Pub. Date: May 16, 2013

(54) DUAL POLARIZATION QUADRATURE MODULATOR

(71) Applicants: GUOMIN YU, Kenmore, WA (US); JONATHAN RANDEL C. MALLARI, SEATTLE, WA (US); ERIC MILLER, SEATTLE, WA (US); BAOQUAN CHEN, Kenmore, WA (US); RALUCA DINU, Santa Clara, WA (US)

(72) Inventors: GUOMIN YU, Kenmore, WA (US); JONATHAN RANDEL C. MALLARI, SEATTLE, WA (US); ERIC MILLER, SEATTLE, WA (US); BAOQUAN CHEN, Kenmore, WA (US); RALUCA DINU, Santa Clara, WA (US)

(73) Assignee: GIGOPTIX, INC., SAN JOSE, CA (US)

(21) Appl. No.: 13/674,058

(22) Filed: Nov. 11, 2012

Related U.S. Application Data
(60) Provisional application No. 61/558,767, filed on Nov. 11, 2011.

(51) Int. Cl. G02F 1/01

(52) U.S. Cl. CPC G02F 1/0134
USPC 385/2; 156/275.5; 156/250

(57) ABSTRACT

A dual polarization quadrature modulator includes an input planar lightwave circuit (PLC) configured to deliver coherent light to a polymer-on substrate device including a plurality of electro-optic (E-O) polymer optical modulation waveguides configured to each phase modulate the coherent light, and the E-O polymer optical modulation waveguides output modulated coherent light to an output PLC configured to combine waveguide pairs of phase modulated light into Mach-Zehnder interferometric signals, combine pairs of Mach-Zehnder interferometric signals into quadrature modulated signals. A polarization rotator rotates modulated light from one of the quadrature modulated signals into an orthogonal polarization. The output PLC combines the quadrature-modulated and rotated quadrature modulated light to form a dual polarization, quadrature modulated light signal. The PLCs and the polymer-on-substrate device are integrated onto a single assembly substrate.

### CROSS REFERENCE TO RELATED APPLICATIONS

The present application claims priority benefit under 35 U.S.C. §119(e) from, and to the extent not inconsistent with this application, incorporates by reference herein U.S. Provisional Patent Application Ser. No. 61/558,767; filed Nov. 11, 2011; entitled “DUAL POLARIZATION QUADRATURE MODULATOR”; invented by Guomin Yu, Jonathan Mallari, Eric Miller, Baoquin Chen and Raluca Dinu.

### SUMMARY

According to an embodiment, a dual polarization quadrature light modulator includes a hybrid assembly of an input planar lightwave circuit (PLC), a thin film polymer on substrate (TFPS) modulator, and/or an output planar lightwave circuit (PLC). An input PLC may be configured to divide and deliver coherent light through a plurality of input interface waveguides. A thin film polymer on substrate (TFPS) modulator includes a plurality of electro-optic (E-O) polymer waveguides, each respectively operatively coupled to receive the divided coherent light from each of at least a portion of the plurality of input interface waveguides, at least a portion of E-O polymer waveguides being configured to modulate the received coherent light. An output PLC includes a plurality of output interface waveguides, at least a portion of which are operatively coupled to receive modulated light from the plurality of E-O polymer waveguides. The output PLC is configured to combine the received modulated light into at least one output waveguide.

According to another embodiment, a method for modulating data onto a light wavelength with a dual polarization quadrature light modulator includes receiving coherent TM-plane polarized light and splitting the coherent light into eight input interface waveguides with an input PLC. Eight respective thin film polymer on substrate (TFPS) electro-optic (E-O) modulator waveguides receive and transmit the coherent light from the eight input interface waveguides. At least one first and at least one second modulated electrical sine data signals are received onto at least one first and at least one second respective high speed sine electrodes, the at least one first high speed sine electrode being operatively coupled to a first pair of the E-O modulator waveguides, and the at least one second high speed sine electrode being operatively coupled to a third pair of the E-O modulator waveguides. Simultaneously, at least one first and at least one second modulated electrical cosine data signals are received onto at least one first and at least one second respective high speed cosine electrodes, the at least one first high speed cosine electrode being operatively coupled to a second pair of the E-O modulator waveguides, and the at least one second high speed cosine electrode being operatively coupled to a fourth pair of the E-O modulator waveguides. The first sine and first cosine modulated electrical data signals are in quadrature, and the second sine and second cosine modulated electrical data signals are in quadrature. Electrical fields produced by the respective high speed electrodes are applied to eight E-O modulator waveguides to cause eight respective phase shifts in the coherent TM-plane polarized light passing therethrough. The phase shifted coherent polarized light is then received with eight output interface waveguides with an output PLC. The output PLC combines the light from the first pair of E-O modulator waveguides, combines the light from the second pair of E-O modulator waveguides, combines the light from the third pair of E-O modulator waveguides, and combines the light from the fourth pair of E-O modulator waveguides to form respective first, second, third, and fourth Mach-Zehnder interferometer modulated light data signals respectively carrying first sine-modulated, first cosine-modulated, second sine-modulated, and second cosine-modulated light. The output PLC then combines the light from the first pair of E-O modulator waveguides and the first Mach-Zehnder interferometer with light from the second pair of E-O modulator waveguides and the second Mach-Zehnder interferometer to produce a first quadrature-modulated light data signal. Simultaneously, the output PLC combines the light from the third pair of E-O modulator waveguides and the third Mach-Zehnder interferometer with light from the fourth pair of E-O modulator waveguides and the fourth Mach-Zehnder interferometer to produce a second quadrature-modulated light data signal. A polarization rotator rotates the polarization plane of the modulated light from the first and second pair of E-O modulator waveguides from TM-plane polarization to TE-plane polarization. (Optionally, the polarization rotator may rotate the light from the first and second pair of E-O modulator waveguides from TM to TE plane polarization prior to combining light from the first and second E-O modulator waveguide pairs.) The output PLC then combines the light from the first quadrature-modulated light data signal (having TE plane polarization) with light from the second quadrature-modulated light data signal (having TM plane polarized light) to produce an output modulated light wavelength data signal including a quadrature-modulated TE-plane polarized light component and a quadrature-modulated TM-plane polarized light component.

According to another embodiment, a method for making a dual polarization quadrature light modulator includes mounting a thin film polymer on substrate (TFPS) modulator die, the TFPS modulator die including a plurality of electro-optic (E-O) modulation waveguides including input ends and output ends in a polymer stack, onto an assembly substrate such that the polymer stack and the E-O modulation waveguides are adjacent to the assembly substrate and the TFPS substrate is spaced away from the assembly substrate by the polymer stack. An input planar lightwave circuit (PLC) die is mounted onto the assembly substrate, the input PLC die including a plurality of input interface waveguides in a waveguide layer on a PLC substrate, while aligning the plurality of input interface waveguides to the input ends of the E-O modulation waveguides of the TFPS. The input PLC is mounted such that the input PLC waveguide layer is adjacent to the assembly substrate and the PLC substrate is spaced away from the assembly substrate by the input PLC waveguide layer. An output PLC die including a plurality of output interface waveguides in a waveguide layer on a PLC substrate is mounted onto the assembly substrate while aligning the plurality of output interface waveguides to the output ends of the E-O modulation waveguides of the TFPS such that the output PLC waveguide layer is adjacent to the assembly substrate and the PLC substrate is spaced away from the assembly substrate by the output PLC waveguide layer.

According to another embodiment, a dual polarization quadrature light modulator may include an input PLC having one or more light source devices integrated with a plurality of input waveguides on one same substrate. For example, the one or more light source devices may include a continuous wave laser.

According to another embodiment, a dual polarization quadrature light modulator may include an output PLC including one or more light detecting devices integrated with a plurality of output waveguides on one same substrate.

### BRIEF DESCRIPTION OF THE FIGURES

FIG. 1 is a schematic view of a dual polarization quadrature modulator, according to an embodiment.

FIG. 2A is a side sectional diagram of the dual polarization quadrature modulator of FIG. 1, according to an embodiment.

FIG. 2B is a side sectional diagram of a dual polarization quadrature modulator, according to another embodiment.

FIG. 3 is a partial cross sectional view of an electro-optic (E-O) modulator waveguide showing alignment to an input waveguide or output waveguide of an input or output planar lightwave circuit (PLC), according to an embodiment.

FIG. 4 is a flow chart showing a method for operating the dual polarization quadrature modulator of FIGS. 1-3, according to an embodiment.

FIG. 5 is a flow chart showing a method for making the dual polarization quadrature modulator of FIGS. 1-3, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

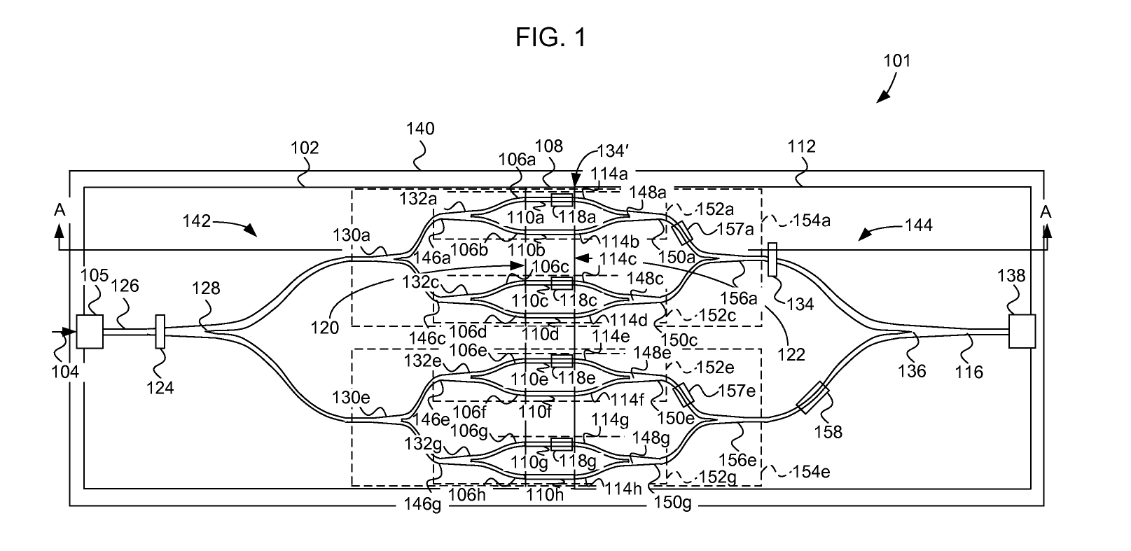

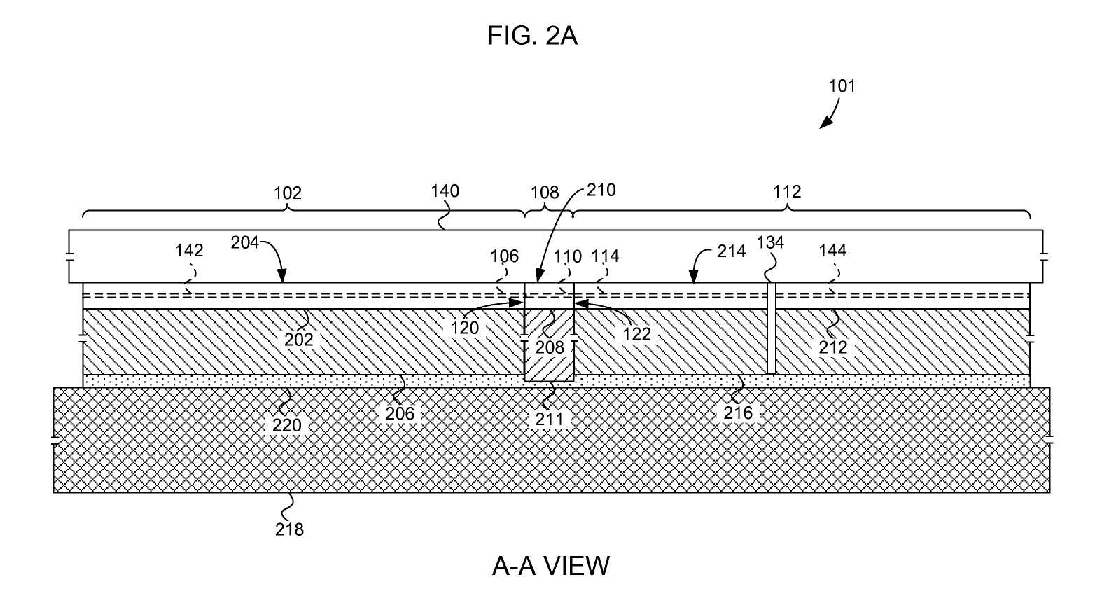

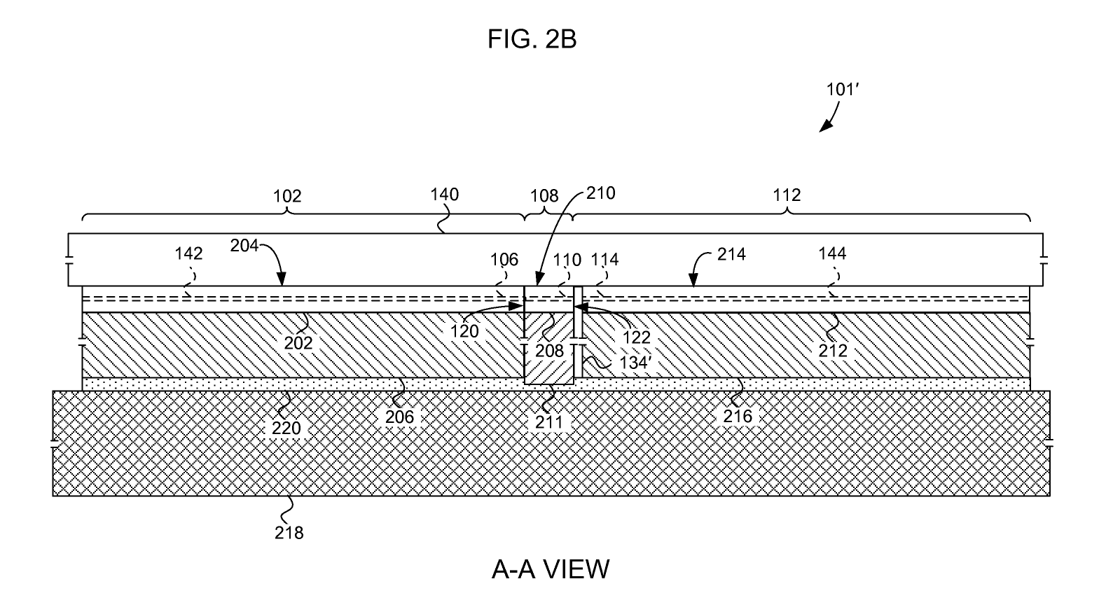

FIG. 1 is a schematic view of a dual polarization quadrature modulator 101, according to an embodiment. FIG. 2A is a side sectional diagram of the dual polarization quadrature modulator 101 of FIG. 1, according to an embodiment. FIG. 2B is a side sectional diagram of an alternative embodiment of the dual polarization quadrature modulator 101″ of FIG. 1, according to an embodiment. The following description may be understood by reference to FIGS. 1, 2A, and 2B.

The dual polarization quadrature light modulator 101 may include an input planar lightwave circuit (PLC) 102 configured to divide and deliver coherent light 104 through a plurality of input interface waveguides 106 a-h. A thin film polymer on substrate (TFPS) modulator 108 may include a plurality of electro-optic (E-O) polymer waveguides 110a-h. Each of the plurality of E-O polymer waveguides 110a-h may be respectively operatively coupled to receive the divided coherent light 104 from each of at least a portion of the plurality of input interface waveguides 106a-h. At least a portion of the E-O polymer waveguides 110a-h may be configured to modulate the received coherent light 104.

An output PLC 112 may include a plurality of output interface waveguides 114a-h. At least a portion of the output interface waveguides 114a-h may be operatively coupled to receive modulated light from the plurality of the E-O polymer waveguides 110a-h. The output PLC 112 may be configured to combine the received modulated light into at least one output waveguide 116.

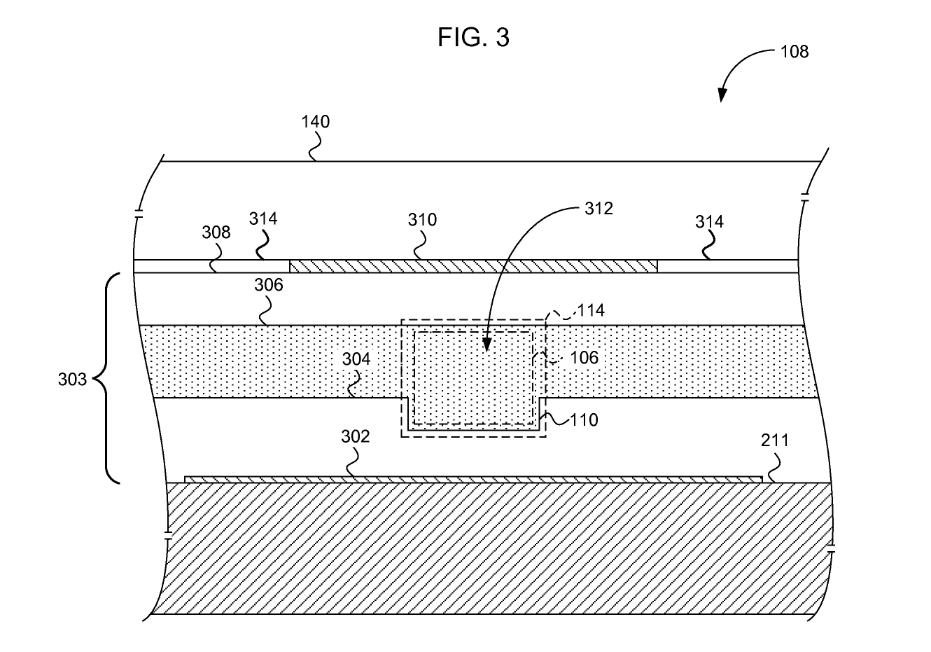

As used herein, a TFPS modulator may refer to a device including polymer optical layers arranged in an optical stack and disposed on a substrate. The substrate may include silicon, and for reasons of clarity may be so referenced herein. The TFPS substrate may alternatively include or consist essentially of other materials such as glass, a semiconductor other than silicon, amorphous silicon, and/or a flexible substrate. The “thin film” polymer optical layer may typically be formed by spin-coating a series of polymer or hybrid siloxyl/polymeric coatings, curing the coating(s), photolithographic patterning, etching (wet and/or dry), and electro-deposition of conductors. Thus, the term “thin film” in TFPS may include layers that are not strictly thin-film as understood by conventional semiconductor engineers. An illustrative cross-sectional structure of a TFPS modulator waveguide is described in conjunction with FIG. 3, below.

The TFPS modulator 108 may include a plurality of first phase bias devices 118a, 118c, 118e, 118g operatively coupled to at least a portion of the plurality of E-O polymer waveguides 110a-h. The plurality of first phase bias devices 118a, 118c, 118e, 118g may include first thermo-optic (T-O) phase bias devices configured to modify a refractive index of a portion of the E-O polymer waveguide 110a-h corresponding thereto.

Placing the first phase bias devices on the TFPS modulator may allow the T-O phase biasing to be performed using lower voltage than alternative first phase biasing being performed by T-O phase bias devices disposed on one of the PLCs.

The TFPS modulator 108 E-O polymer waveguides 110a-h may each include a light input facet 120 and a light output facet 122 formed by dicing a substrate 211 and thin film polymer 208. Alternatively, the light input facet 120 and light output facet 122 may be formed by scoring a substrate 211 and propagating a crack across the thin film polymer 208.

The coherent light 104 delivered through the plurality of input interface waveguides 106a-h to the TFPS modulator 108 may be substantially TM plane polarized. The dual polarization quadrature light modulator 101 may include a TM plane polarizer 124 included in or operatively coupled to the input PLC 102. Alternatively, the received coherent light 104 may be TM plane polarized.

According to embodiments, the TFPS 108 E-O waveguides 110a-h have significantly higher coupling to TM plane polarized light (polarized light having a plane of polarization orthogonal to the surfaces 204, 210, 214 of the input PLC 102, TFPS 108, and the output PLC 112) than to TE plane polarized light (TE plane polarized light having a plane of polarization parallel to the surfaces 204, 210, 214). For an ideally poled E-O device and perfectly TE plane polarized light, the TFPS E-O modulator may have substantially no effect on light propagation velocity. For this reason, the input light to the TFPS E-O waveguides 110a-h is preferably TM plane polarized.

The input PLC 102 may include an input waveguide 126 and a plurality of input interface waveguide splitters 130a, 130e, 132a, 132c, 132e, 132g configured to split input coherent light from the input waveguide to deliver coherent light to each of the input interface waveguides. For example, the splitters 130a, 130e, 132a, 132c, 132e, 132g may each provide substantially 50:50 split of energy. According to another embodiment, the power split of one or more of the splitters 130a, 130e, 132a, 132c, 132e, 132g may differ from 50:50, for example to accommodate systemic variations in loss through the waveguides, polarization rotator 134, etc.

The output PLC 112 may include a polarization rotator 134 operatively coupled to a first portion of the E-O polymer waveguides 110a-d, the polarization rotator 134 being configured to rotate the TM modulated light from the first portion of the E-O polymer waveguides 110a-d to TE plane polarized light. For example, the polarization rotator 134 may include a thin film device or a half-wave plate. The output PLC 112 may be diced into two sections (as shown in FIG. 2A) and the polarization rotator 134 may be mounted between the sections in a region corresponding to the first portion of the E-O polymer waveguides 110a-d. Alternatively, the output PLC 112 may include a groove formed (such as by deep reactive ion etching, DRIE) across an output PLC 112 waveguide 144 section corresponding to the first portion of the E-O polymer waveguides 110a-d, and the polarization rotator 134 may be mounted in the groove.

The output PLC 112 may include an optical combiner 136 operatively coupled to the first portion of the E-O polymer waveguides 110a-d and a second portion of the E-O polymer waveguides 110e-h, and configured to combine the TE plane polarized light from the first portion of the E-O polymer waveguides 110a-d and the polarization rotator 134 with TM plane polarized light from the second portion of the E-O polymer waveguides 110e-h. An output waveguide 116 operatively coupled to the combiner 136 may be configured to carry the combined TE and TM plane polarized light. An output optical coupler 138 operatively coupled to the output waveguide 116 may be configured to couple the combined TE and TM plane polarized light to an optical fiber or another waveguide device (not shown).

The dual polarization quadrature light modulator 101 may further include an assembly substrate 140. The input PLC 102, the TFPS modulator 108, and the output PLC 112 may be mounted on the assembly substrate 140 with their respective waveguides 142, 110a-h, 144 adjacent to the assembly substrate 140. Thus, the individual substrates 106, 211, 216 may be mounted away from the assembly substrate 140, separated from it by the respective waveguide layers 202, 208, 212. The assembly substrate 140 may be configured to provide vertical alignment between the waveguides 110a-h of the TFPS modulator 108 and the waveguides 142, 144 of the input and output PLCs 102, 112.

The substrates 206, 216 and 211 of the PLCs 102, 112 and the TFPS 108 may be produced in different facilities or different areas of one facility. It is possible that the PLC substrates 206, 216 and the TFPS substrate 211 may have a slightly different thickness. Alternatively or additionally, the TFPS 108 may include integrated circuitry having layers of conductor and dielectric, or one or both of the PLCs 102, 112 may have extra layers formed thereon. Similarly, optical stack thicknesses such as bottom clad thicknesses may vary from die to die. By flipping the PLCs 102, 112 and the TFPS modulator 108 and mounting them top-down (the “top” being a side including waveguide structures 142, 110a-h, 144) on the assembly substrate 140, the respective waveguides of the PLCs 102, 112 and the TFPS modulator 108 may be better aligned vertically, despite differences in die 102, 112, 108 thicknesses or circuitry thicknesses between the die substrates 206, 211, 216 and the waveguide structures 142, 110a-h, 144.

The assembly substrate 140 may be formed from a substantially 1 millimeter thick glass slide, for example.

The dual polarization quadrature light modulator 101 may include structures configured to cooperate to form a first Mach-Zehnder interferometer (MZ) 152a. For example, the first MZ 152a may include a first input intermediate waveguide 146a, a first input splitter 132a operatively coupled to the first intermediate waveguide 146a and configured to split coherent light 104 received from the first input intermediate waveguide 146a onto two first input interface waveguides 106a, 106b on the input PLC 102. A first pair of E-O polymer waveguide modulation channels 110a, 110b may be respectively aligned to receive coherent light from the two first input interface waveguides 106a, 106b. Two first output interface waveguides 114a, 114b on the output PLC 112 may be aligned to receive modulated coherent light from the first pair E-O polymer waveguide modulation channels 110a, 110b. A first output combiner 148a operatively coupled to the two first output interface waveguides 114a, 114b may be configured combine the received light onto a first output intermediate waveguide 150a on the output PLC 112.

Similarly, a second input intermediate waveguide 146c, a second input splitter 132c coupled to the second intermediate waveguide 146c and configured to split coherent light received from the second input intermediate waveguide 146c onto two second input interface waveguides 106c, 106d on the input PLC 102; a second pair of E-O polymer waveguide modulation channels 110c, 110d respectively aligned to receive coherent light from the two second input interface waveguides 110c, 110d; two second output interface waveguides 114c, 114d on the output PLC 112 aligned to receive modulated coherent light from the second pair E-O polymer waveguide modulation channels 110c, 110d; and a second output combiner 148c operatively coupled to the two second output interface waveguides 114c, 114d and configured to combine the received light onto a second output intermediate waveguide 150c on the output PLC may be configured to cooperate to form a second MZ 152c.

Each MZ 152a, 152c, 152e, 152g may operate in a push-pull manner. For example a first “arm” of the MZ 152a may include an E-O waveguide 110a that increases refractive index while a second arm includes an E-O waveguide 110b that decreases refractive index to output a binary 0. For example, applying respective ±V_{π} voltages across the waveguides 110a, 110b may result in a phase difference of π (180°) between coherent light output from the E-O waveguides 110a, 110b; which when combined by the combiner 148a, results in destructive interference to produce no light output. Conversely, reversing the signs of the ±V_{π} voltages across the waveguides 110a, 110b may result in a phase difference of 0 (zero) (=2π). When combined by the combiner 148a, the reversed voltage signals result in constructive interference of the modulated coherent light to produce light output corresponding to a binary 1. Other combinations of transitions, voltages, and/or chromophore poling may alternatively be used to modulate data from the MZs 152a, 152c, 152e, 152g.

The first and second Mach-Zehnder interferometers 152a, 152c may be configured to cooperate to form a first quadrature phase shift keying (QPSK) or differential quadrature phase shift keying (DQPSK) light modulator 154a. A thermo-optic quadrature phase bias device 156a disposed on the input PLC 102 or the output PLC 112, operatively coupled to one of the first or the second Mach-Zehnder interferometer 152a, 152c may be configured to maintain a sine-cosine (orthogonal) phase relationship between the first and second Mach-Zehnder interferometers 152a, 152c to keep the QPSK or DQPSK light modulator 154a in phase.

The thermo-optic quadrature phase bias device 156a, 156e may be formed from a heater electrode operatively coupled to an intermediate waveguide on the input PLC 102 or the output PLC 112. Heating the intermediate waveguide alters its refractive index, which can be used to retard light from one Mach-Zehnder interferometer 152a to keep it in phase (coherent) with light from the other Mach-Zehnder interferometer 152c.

The dual polarization quadrature light modulator 101 may also include third and fourth Mach-Zehnder interferometers 152e, 152g formed on the input PLC 102, TFPS modulator 108, and output PLC 112; and configured to operate as a second QPSK or DQPSK light modulator 154e. A polarization rotator 134 operatively coupled to an output waveguide 156a of the first QPSK or DQPSK light modulator 154a may be configured to rotate the polarization of the first QPSK or DQPSK modulated coherent light from TM to TE plane polarization. A combiner 136 may be configured to combine the TE plane polarized light from the first QPSK or DQPSK light modulator 154a with TM plane polarized light from the second QPSK or DQPSK light modulator 154e to form a single light signal on an output waveguide 116 including two separable QPSK or DQPSK modulated light signals.

The dual polarization quadrature light modulator 101 may include a (T-O) polarization phase bias device 158 configured to shift the phase of light from the first or the second QPSK or DQPSK light modulator 154a, 154e to match the phase of the other QPSK or DQPSK light modulator.

The dual polarization quadrature light modulator 101 may include a respective high speed electrode (e.g., see FIG. 3 310) operatively coupled to each E-O modulation waveguide 110a-h. The coherent light 104 may consist essentially of a single wavelength. For example, the coherent light 104 may include light in the C or L band at about 1510 to 1620 nanometers wavelength. According to one embodiment, the light is at about 1550 nanometers wavelength. For example, the coherent light 104 may include one of a plurality of wavelength division multiplexed (WDM) channels selected from the C or L data transmission WDM band. Optionally, the dual polarization quadrature light modulator 101 may be configured to receive a plurality of wavelengths, and the input PLC 102 may include a filter (not shown) configured to split the plurality of wavelengths and deliver a selected wavelength to each quadrature modulator or dual polarization pair of quadrature modulators 154a, 154e.

Alternative embodiments 101 and 101′ are shown in FIGS. 2A and 2B. The dual polarization quadrature light modulator 101 may include a polarization rotator 134′ (shown in FIG. 2B) mounted between the TFPS modulator 108 and the output PLC 112 in a region corresponding to a portion of the E-O polymer waveguides 110a-d. The polarization rotator 134′ may be configured to rotate TM plane polarized light received from the portion of the E-O polymer waveguides 110a-d to TE plane polarized light prior to the light entering the output PLC 112. Mounting the polarization rotator 134′ between the TFPS modulator 108 and the output PLC 112 may simplify assembly, reduce part count, and/or reduce losses because the arrangement makes use of an existing interface between parts rather than inserting a dedicated interface (such as a groove or split) between portions of the output PLC 112.

In either embodiment 101 or 101′, the waveguides 142 of the input PLC 102, the E-O modulation waveguides 110a-h of the TFPS modulator 108, and the waveguides 144 of the output PLC 112 (the visible surfaces shown through the assembly substrate 140 in FIG. 1) may each be formed in respective waveguide layers 202, 208, 212 adjacent to surfaces 204, 210, 214 on respective substrates 206, 211, 216. The waveguides 142, 110a-h, 144 may be held in mutual alignment in a Z-axis (vertical, as shown in FIGS. 2A, 2B) by mounting the surfaces 204, 210, 214 adjacent to the assembly substrate 140. A mounting substrate 218 may be configured to carry the input PLC 102, the TFPS modulator 108, the output PLC 112, and an assembly substrate 140. The mounting substrate 218 may be configured to carry the dual polarization quadrature light modulator 101 for operative coupling to at least one of a package (not shown), a heat sink (not shown), or to one or more additional waveguide devices (not shown). A thermal gasket or thermal gel 220 may be configured to thermally couple at least the TFPS light modulator 108 to the mounting substrate 218. Optionally, the thermal gasket or thermal gel 220 may be configured to thermally couple the input PLC 102 and/or the output PLC 112 to the mounting substrate 218.

As an alternative to the embodiments described above, since the TE and TM light output from the dual polarization quadrature light modulator do not constructively or destructively interfere in the way quadrature modulated light of the same polarization interacts, the coherent light received by the dual polarization quadrature modulator 101 may be operatively coupled to or may include two different coherent light sources, one providing TM light for output as TM light, and the other providing TM light for output as TE light.

Optionally, the input PLC 102 may include one or more light source devices (not shown) integrated with a plurality of input waveguides 142 on one same substrate 106. For example, the one or more light source devices may include a continuous wave laser. Optionally, the input PLC 102 may include other devices such as a multimode interference (MMI) coupler, a directional coupler, a multiplexing section, and/or a demultiplexing section.

Optionally, the output PLC 112 may include one or more light detecting devices (not shown) integrated with a plurality of output waveguides 144 on one same substrate 216. Optionally, the output PLC 112 may include a multimode interference (MMI) coupler, a directional coupler, a multiplexing section, and/or a demultiplexing section.

According to alternative embodiments, the light modulator 101 may include polarization channels, but omit quadrature channels. For example, a first (TE) polarization channel may be formed using a first single MZ interferometer 152a and a second (TM) polarization channel may be formed using a second single MZ interferometer 152e. The second and fourth MZ interferometers 152c, 152g may be omitted. With omission of the quadrature MZ interferometers 152c, 152g, the quadrature modulators 154a, 154e may also be omitted. The light modulator 101 may be operated, for example, as a phase shift keying (PSK) or differential phase shift keying (DPSK) modulator.

FIG. 3 is a partial cross sectional view of an E-O modulator waveguide 110 showing alignment to an input interface waveguide 106 and/or output interface waveguide 114 of an input or output PLC 102, 112, according to an embodiment. A semiconducting or insulating substrate 211 may support at least one conductor layer patterned over the substrate 211 and configured to act as a ground electrode 302. A planarization layer (not shown) may optionally be disposed at least partly coplanar with and over the ground electrode 302. An optical polymer stack 303 (also referred to herein as “thin film polymer”, as in TFPS) may be disposed over the substrate 211 and ground electrode 302. According to an alternative embodiment, the planarization layer (not shown) may be omitted, and the planarization function may be provided by a portion of the optical polymer stack 303.

A top conductor layer may be disposed over the optical polymer stack 303 and patterned to form a high speed electrode 310 configured to cooperate with the ground electrode 302 to apply a pulsed electrical field through the E-O waveguide 110.

The top conductor layer may be formed to include a metal layer, a superconductor layer, or a conductive polymer, for example. The top conductor may be plated to increase its thickness. The high speed electrode may be operatively coupled to receive an electrical signal from a quadrature driver (not shown). According to embodiments, the ground electrode 302 may be disposed parallel to the high speed electrode 310. An active region 312 of the optical polymer stack 303 including an E-O waveguide 110 may be positioned to receive a modulation signal from the high speed electrode 310 and the ground electrode 302. The active region 312 includes an E-O composition formed as a poled region that contains at least one second order nonlinear optical chromophore. Chromophores and electro-optic compositions are described more fully below.

The optical polymer stack 303 is configured to support the active region 312. The optical polymer stack 303 may include at least one bottom cladding layer 304 and at least one top cladding layer 308 disposed respectively below and above an electro-optic layer 306. The bottom 304 and top 308 cladding layers, optionally in cooperation with an optional planarization layer, are configured to guide inserted light 104 along a path in the plane of the electro-optic layer 306. Light guiding structures 110 are formed in the optical polymer stack 303 to guide the light 104 along one or more light propagation paths through the electro-optic layer 306. In the embodiment of FIG. 3, the guidance structure 110 is formed as a trench waveguide that includes an etched path in the at least one bottom cladding layer 304. Optionally, other waveguide structures may be used. For example a quasi-trench, rib, quasi-rib, side clad, etc. may be used singly or in combination to provide light guiding functionality.

According to an embodiment, the TFPS 108 may include a velocity-matching layer (not shown). The electro-optic polymer layer 306 may have a variable optical propagation velocity of light passed through it, which may, for example, be dependent on an electric field provided by the high speed electrode 310 in cooperation with a ground electrode 302. The high-speed electrode 310 may be disposed over the top cladding layer 308 and under the velocity-matching layer (not shown), the high-speed electrode 310 having an electrical propagation velocity of electrical pulses passed through it. The velocity-matching layer may be configured to cause the electrical propagation velocity through the high speed electrode 310 to approximate the optical propagation velocity through the electro-optic polymer layer 306. The top cladding layer 308 may be disposed over the electro-optic polymer layer 306 and below the velocity-matching layer (not shown), and may be configured to guide the coherent light to pass substantially through the E-O polymer layer 306. For typical waveguide applications, the top cladding layer 308 may be configured to convey a portion of light energy that is nominally passed through the electro-optic polymer layer 306. According to an alternative embodiment, the velocity-matching layer (not shown) may be formed under the high speed electrode 310 and over the top cladding layer 308.

According to another embodiment, the assembly substrate 140 may be selected to have a permittivity that provides the velocity-matching function of a separate velocity-matching layer.

To provide the velocity matching, the permittivity of the velocity-matching layer (not shown) may be selected to cause the electrical propagation velocity through the high speed electrode 310 to approximate the optical propagation velocity through the electro-optic polymer layer 306, and particularly through the electro-optic waveguide core 110. According to an embodiment, the velocity-matching layer includes a polymer made from a monomer, an oligomer, or a monomer and oligomer mixture containing the monomer:

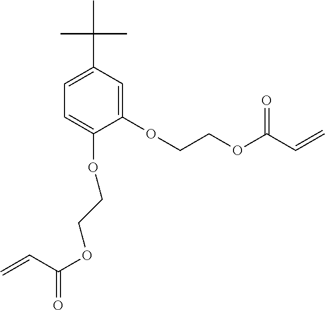 [SMILES: C=CC(=O)OCCOc1ccc(C(C)(C)C)cc1OCCOC(=O)C=C]

Polymerization of the velocity-matching layer may be radiation-initiated. For example, the velocity-matching layer may include a photoinitiator, a photosensitizer with an initiator, or a mixture of a photoinitiator and a photosensitizer with an initiator.

According to embodiments, the layers 304, 306, 308 may be formed by spin coating followed by drying, polymerization, and/or cross-linking. According to embodiments, the bottom clad 304 may be formed to have a thickness of 2.4 to 2.8 micrometers. The trench waveguide 110 may be etched into the bottom clad 304 to a depth of 1.0 to 1.2 micrometers, leaving a 1.4 to 1.6 micrometer thickness of bottom clad 304 under the trench waveguides 110. The trench waveguides 110 may be etched to a width of 3.8 to 4.0 micrometers. The electro-optic polymer 306 may be formed to have a thickness of 2.15 to 2.2 micrometers over the bottom clad 304 surface, thus having a thickness of 3.15 to 3.4 micrometers through the trench waveguide 110. The top clad 308 may be formed to have a thickness of 1.4 to 1.6 micrometers. An optional velocity-matching layer (not shown) may be formed to have a thickness of 6 to 8 micrometers, or may be formed integrally with the assembly substrate 140. The top electrode 310 width may be about 12 micrometers.

Typically the refractive indices of the one or more bottom cladding layers 304, E-O polymer layer 306, and one or more top cladding layers 308 are selected to guide at least one wavelength of light along the core. For example, the top and bottom clad layers 308, 304 may be selected to have an index of refraction of about 1.35 to 1.60 and the E-O polymer layer 306 may be selected to have a nominal index of refraction of about 1.57 to 1.9. According to one illustrative embodiment, the top and bottom clad layers 308, 304 have an index of refraction of about 1.50 and the E-O polymer layer 306 has an index of refraction of about 1.74. According to embodiments, the one or more bottom clad, side clad, and/or one or more top clad layers may include materials such as polymers (e.g., crosslinkable acrylates or epoxies or electro-optic polymers with a lower refractive index than electro-optic polymer layer), inorganic-organic hybrids (e.g., “sol-gels”), and inorganic materials (e.g., SiOx).

The top clad 308 (or optional velocity matching layer (not shown)) may be adhered to an assembly substrate 140 using an optical adhesive 314, for example. Optionally, the high speed electrode 310 may be formed on the assembly electrode. For example, a patterned (e.g., via hard mask) region of titanium dioxide and/or vacuum deposited gold, aluminum, or silver may act as a seed layer for receiving electroplating in a solution reaction.

As described above, the assembly substrate 140 may provide vertical alignment between the E-O waveguides 110 and the input PLC input interface waveguides 106, shown as a dashed line that is at least approximately aligned with the guidance structure of the E-O waveguide 110. Similarly, the assembly substrate 140 may provide vertical alignment between the E-O waveguides 110 and the output PLC output interface waveguides 114, as also shown by the dashed line. The difference in indicated sizes between the E-O waveguide structure 110 and the indicated positions of the input interface waveguides 106, E-O waveguides 110, and output interface waveguides 114 may be representative of a plurality of embodiments. For example, according to one embodiment, the difference in indicated sizes of the waveguides 110, 106, 114 may be interpreted as approximate tolerances in location and/or size. According to another embodiment, the difference in indicated sizes of the waveguides 110, 106, 114 may be indicative of tapers configured to capture light respectively launched from the input interface waveguides 106 to the E-O waveguides 110, launched from the E-O waveguides 110 to the output interface waveguides 114. According to another embodiment, the difference in indicated sizes of the waveguides 110, 106, 114 may be indicative of refractive index adjustments between the input PLC 102, TFPS modulator 108, and output PLC 112. According to another embodiment, there may be substantially no difference in actual size between the waveguides 110, 106, 114; and the figure may drawn with the structures non-overlapping as a device to reveal three planes.

Second order non-linear optical chromophores are generally formed as molecules having a structure D-π-A, where D is an electron donor structure, A is an electron acceptor structure having a relatively higher electron affinity than the electron donor structure D, and t is a pi-orbital conjugated bridge that permits electron flow between the donor D and the acceptor A. Such molecules may also be referred to as hyperpolarizable organic chromophores. The molecules are generally linear and nominally polar due to the difference in electron affinities between the donor D and acceptor A. Such molecules may be poled into alignment by applying an electrical poling field during manufacture, with the acceptor A portions being drawn toward a positive potential and the donor D portions being drawn toward a negative potential. The molecules may then be locked into the desired alignment by cross-linking or freezing a polymer matrix in which the chromophores are embedded. For example, poling can occur near a glass transition temperature Tg of a composition including a host polymer and chromophores. Alternatively, the chromophores may be covalently bound or otherwise substantially fixed in their poled positions.

Illustrative chromophore structures B71 and B74 (including bulky group substitutions) synthesized by the applicant are shown below. The B71 and B74 chromophores show good compatibility with host polymers and lead to high glass transition temperatures and high (Telcordia) stability.

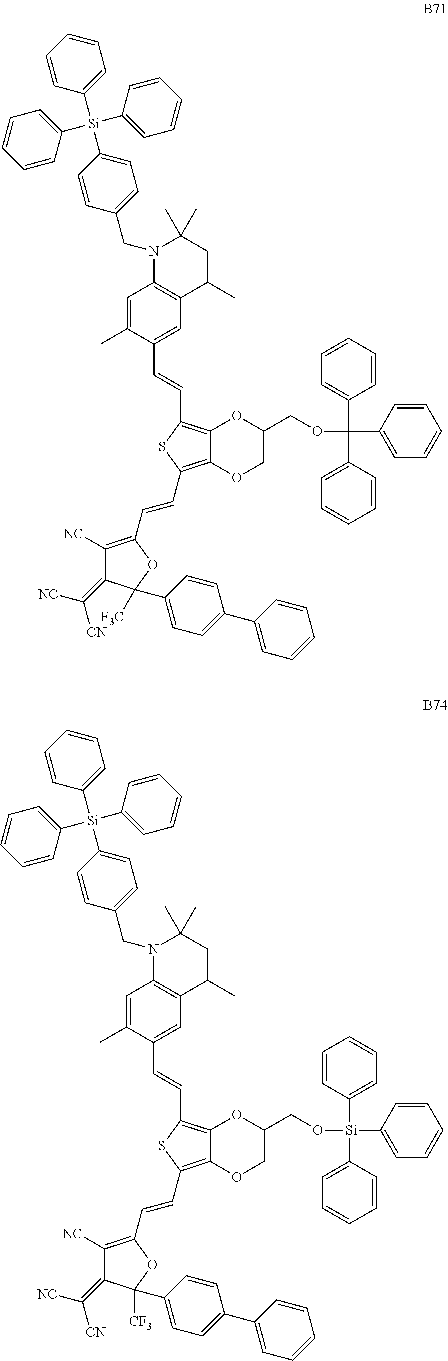 [SMILES: Cc1cc2c(cc1/C=C/c1sc(/C=C/C3=C(C#N)C(=C(C#N)C#N)C(c4ccc(-c5ccccc5)cc4)(C(F)(F)F)O3)c3c1OC(COC(c1ccccc1)(c1ccccc1)c1ccccc1)CO3)C(C)CC(C)(C)N2Cc1ccc([Si](c2ccccc2)(c2ccccc2)c2ccccc2)cc1 ; Cc1cc2c(cc1/C=C/c1sc(/C=C/C3=C(C#N)C(=C(C#N)C#N)C(c4ccc(-c5ccccc5)cc4)(C(F)(F)F)O3)c3c1OC(CO[Si](c1ccccc1)(c1ccccc1)c1ccccc1)CO3)C(C)CC(C)(C)N2Cc1ccc([Si](c2ccccc2)(c2ccccc2)c2ccccc2)cc1]

Approaches for synthesizing the B71 and B74 chromophores depicted above are disclosed in U.S. patent application Ser. No. 12/959,898, entitled Stabilized Electro-Optic Materials and Electro-Optic Devices Made Therefrom, filed Dec. 3, 2010; and in U.S. patent application Ser. No. 12/963,479, entitled Integrated Circuit with Optical Data Communication, filed Dec. 8, 2010; which are, to the extent not inconsistent with the disclosure herein, incorporated by reference in their entirety, and for purposes beyond showing approaches for synthesis.

According to embodiments, the E-O layer 306 may be composed of a host polymer in which one or more chromophores are held as guest molecules by non-covalent bonding. Guest-host systems using the B71 and B74 chromophores were synthesized using various host polymers including host polymers in the polycarbonate family such as the molecular structures shown below:

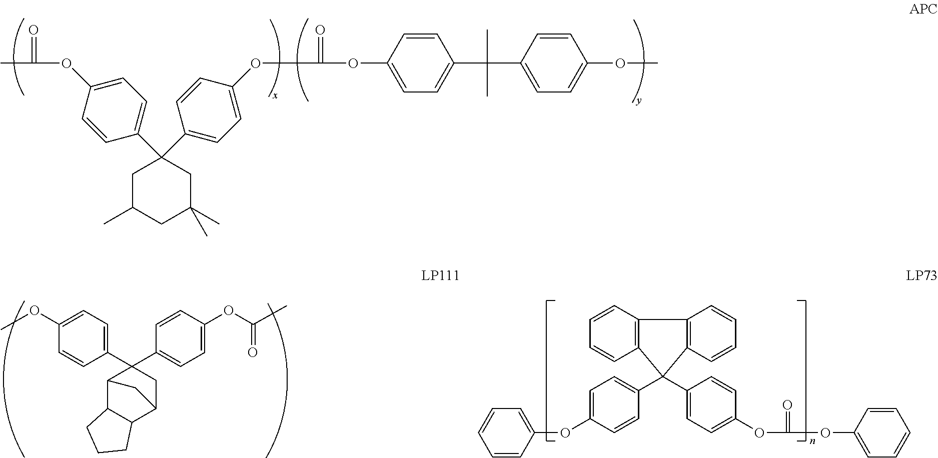

Polymers that may be used as host polymers may include, for example, polycarbonates, poly(arylene ether)s, polysulfones, polyimides, polyesters, polyacrylates, and copolymers thereof. Chromophores and corresponding electro-optic compositions that provide high thermal and/or temporal stability can be advantageous with respect to processing constraints, yield, service temperature constraints, reliability, and service life. As may be appreciated, the illustrative host polymers shown above include aryl groups. The illustrative chromophores B71 and B74 also include aryl groups. For example, non-electrically conjugated aryl groups such as triaryl groups may be attached to the electron donor (D), pi-conjugated bridge (π), and/or the electron acceptor (A) portions of a chromophore. Such non-conjugated aryl groups may alternatively be referred to as bulky groups. Approaches for improving thermal and temporal stability may include establishing interactions between the aryl (bulky) groups of the chromophore(s) with aryl groups of the host polymer to help prevent depoling (with concomitant loss of E-O activity) during service and at other times after poling.

Physical interactions may include, for example, pi-pi interactions, size interactions that block chromophore movement significantly below Tg (e.g., there is not enough free volume in the polymer composite at Tg for translation of the bulky group, and hence the chromophore, which is generally required for chromophore relaxation), and preorganized binding interactions where the bulky groups fit preferentially into conformationally defined spaces in the polymer, or any combination thereof. In some embodiment, the physical interactions are controlled or supplemented by van der Waals forces (e.g., Keesom, Debye, or London forces) among the moiety of the bulky groups and aryl groups on polymer chains. Such non-covalent interactions may increase temporal stability below Tg and decrease optical loss while improving chromophore loading density and avoiding the deleterious effects of crosslinking on the degree of poling-induced alignment.

Pi-pi interactions are known in the art and may include interaction, for example, between a pi-system and another pi-system (e.g., an aromatic, a heteroaromatic, an alkene, an alkyne, or carbonyl function), a partially charged atoms or groups of atoms (e.g., —H in a polar bond, —F), or a fully charged atom or groups of atoms (e.g., —NR(H)₃⁺, —BR(H)₃⁻). pi-interaction may increase affinity of the chromophore guest for the polymer host and increase energy barriers to chromophore movement, which is generally required for chromophore relaxation and depoling. In some embodiments, pi-interactions may be used to raise the Tg of a polymer (e.g., by increasing interactions between polymer chains) or the Tg of a polymer composite (e.g., by increasing interactions between the polymer host and the chromophore guest). In some embodiments, the pi-interactions of the bulky groups increase the Tg of the polymer composite compared to when pi-interacting moieties on the bulky groups are replaced with moieties that have no or weak pi-interactions. In some embodiments, pi-interacting groups on the chromophore are chosen to interact preferentially with pi-interacting groups on the polymer chain. Such preferential interactions may include, for example, pi-interacting donors/acceptors on the bulky group with complementary pi-interacting acceptors/donors of the polymer chain, or spatial face-to-face and/or edge-to-face interactions between pi-interacting groups on the chromophores and polymer chains, or any combination thereof. In some embodiments, multiple interactions such as a face-to-face and face-to-edge between one or multiple moieties on the chromophore bulky group with multiple or one moieties on the polymer chain may increase interaction strength and temporal stability. The pi-interactions between the aryl bulky group(s) on the chromophore and the aryl groups on the polymer may be enhanced by complementary geometric dispositions of the aryl groups that enhance the pi interactions (e.g., aryl groups tetrahedrally disposed around a substituent center in the chromophore bulky group may favorably pi-interact (e.g., stack) with aryl groups tetrahedrally disposed around a carbon in the polymer backbone).

A poling process was performed at a temperature range from 164° C. to 220° C. with a positive and/or negative bias voltage ranging from 90 volts per micrometer (V/μM) to 200 V/μM to align the chromophores. The choice of poling temperature and voltage depends on the E-O layer 306 materials.

Other properties that contribute to a successful integration of the optical polymer stack 303 with the substrate 211 include good adhesion to metal, oxide, and semiconductor portions of the substrate surface, sufficient elasticity to compress or stretch corresponding to thermal expansion of the substrate 211 and substrate portions, low optical loss, and high electro-optic activity. Such considerations can be satisfied by material systems described herein.

After poling, an electrical modulation field may be imposed through the volume of chromophores. For example, if a relatively negative potential is applied at the negative end and a relatively positive potential applied at the positive end of the poled chromophores, the chromophores will at least partially become non-polar. If a relatively positive potential is applied at the negative end and a relatively negative potential is applied at the positive end, then the chromophores will temporarily hyperpolarize in response to the applied modulation field. Generally, organic chromophores respond very quickly to electrical pulses that form the electrical modulation field and also return quickly to their former polarity when a pulse is removed.

A region of poled second order non-linear optical chromophores generally possesses a variable index of refraction to light. The refractive index is a function of the degree of polarization of the molecules. Thus, light that passes through an active region will propagate with one velocity in a first modulation state and another velocity in a second modulation state. This property, along with the fast response time and a relatively high sensitivity to changes in electric field state make second order non-linear optical chromophores excellent bases from which to construct a high speed E-O waveguide 110 that may be combined into quadrature optical modulators 154a, 154e, as described in conjunction with FIGS. 1, 2A, and 2B.

According to an embodiment, a driver circuit (not shown) may be configured to drive the electrodes 302, 310 with a series of modulated electrical pulses. A resultant modulated electrical field is thus imposed across the E-O waveguide 110 and results in modulated hyperpolarization of the poled chromophores embedded therein. A complex of electrodes 302, 310 and the active region and light guidance structure 110 may be designated as an optical device. The modulated hyperpolarization may thus modulate the velocity light passed through the poled E-O waveguide of the optical polymer stack 303. Repeatedly modulating the velocity of the transmitted light creates a phase-modulated light signal emerging from the active region. As described above, such an active region 110 may be combined with light splitters, combiners, and other active regions to create light amplitude modulators, such as in the form of a Mach-Zehnder optical modulator 152a, 152c, 152e, 152f, shown in FIG. 1.

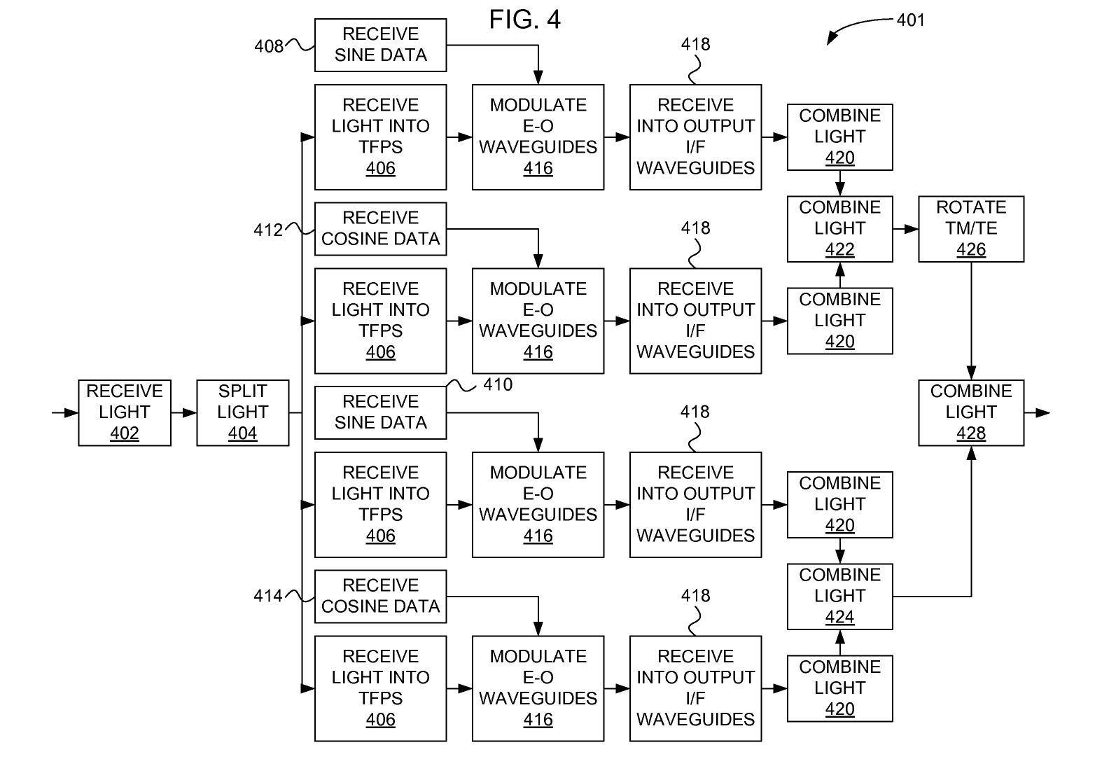

FIG. 4 is a flow chart showing a method 401 for operating the dual polarization quadrature modulator 101 of FIGS. 1-3, according to an embodiment. The method 401 may begin at step 402, wherein coherent TM-plane polarized light is received. Optionally, the method 401 may include polarizing received coherent light to TM-plane polarization. Step 402 may then be performed at a node “downstream” from the polarizer.

Optionally, receiving the coherent light in step 402 may include receiving a first channel of coherent light corresponding to a first quadrature modulator (FIG. 1, 154a) and receiving a second channel of coherent light corresponding to a second quadrature modulator (FIG. 1, 154e). The first and second channels of coherent light may be incoherent with each other.

Proceeding to step 404, the coherent light is split into eight input interface waveguides with an input PLC.

Proceeding to step 406, the coherent light from the eight input interface waveguides is received and transmitted as eight respective channels of coherent light through eight respective TFPS E-O modulator waveguides. For example, receiving the coherent light from the eight input interface waveguides and transmitting eight respective channels of coherent light through eight respective (TFPS) electro-optic (E-O) modulator waveguides may include receiving light through an edge facet (FIGS. 1, 2A, 2B, 120) in the thin film polymer. The edge facet (FIGS. 1, 2A, 2B, 120) may be formed by dicing the substrate and polymer film (FIGS. 2A, 2B, 211) of the TFPS die, or by scoring the substrate and propagating a crack through the substrate and through the optical polymer stack (FIG. 3, 303).

Step 408, which may occur substantially simultaneously with step 406, includes receiving at least one first modulated electrical sine data signal(s) onto at least one first high speed sine electrode(s). The first high speed sine electrode(s) may be operatively coupled to a first pair of the E-O modulator waveguides. According to one embodiment, receiving at least one first modulated electrical sine data signal may include receiving two first modulated electrical sine data signals onto respective high speed sine electrodes, each data signal being the inverse of the other, and each high speed sine electrode being operatively coupled to a respective one of a push-pull pair of E-O modulator waveguides (see FIG. 1, 110a, 110b).

Step 410, which may occur substantially simultaneously with step 408, includes receiving at least one second modulated electrical sine data signal(s) onto at least one second high speed sine electrode(s). The second high speed sine electrode(s) may be operatively coupled to a third pair of the E-O modulator waveguides. According to one embodiment, receiving at least one second modulated electrical sine data signal may include receiving two first modulated electrical sine data signals onto respective high speed sine electrodes, each data signal being the inverse of the other, and each high speed sine electrode being operatively coupled to a respective one of a push-pull pair of E-O modulator waveguides (see FIG. 1, 110e, 110f). The signals described in steps 408 and 410 may be synchronously modulated (e.g., but with different data), but because they drive respective quadrature modulators (see FIG. 1, 154a, 154e) that do not intrinsically require synchronous modulation to operate (because of their respective positions configured to drive TE and TM components of a dual polarization light signal), the sine signal(s) received in step 410 may alternatively be asynchronous (though often simultaneous, depending on system data transmission requirements).

Step 412 may generally be performed simultaneously and synchronously with step 408. Step 412 includes receiving at least one first modulated electrical cosine data signal(s) onto at least one first high speed cosine electrode(s). For example, the first high speed cosine electrode(s) may be operatively coupled to a second pair of E-O modulator waveguides. According to one embodiment, receiving at least one first modulated electrical cosine data signal 412 may include receiving two first modulated electrical cosine data signals onto respective high speed cosine electrodes, each data signal being the inverse of the other, and each high speed cosine electrode being operatively coupled to a respective one of a push-pull pair of E-O modulator waveguides (e.g., see FIG. 1, 110c, 110d).

According to embodiments, receiving at least one first sine and at least one first cosine modulated electrical signals 408, 412 may include receiving quadrature amplitude modulated (QAM), quadrature phase shift keying (QPSK), or differential quadrature phase shift keying (DQPSK) modulated electrical signals.

The synchronicity between steps 408 and 412 may, in some embodiments, be treated as an ideal. For example, real hardware may execute jitter, skew, or even period offset and still be considered to behave according to the recitation of synchronously receiving the first sine and the first cosine signal. Typically, it may be preferable to be as synchronous (as close to quadrature) as possible to minimize receiver complexity, maximize range, and/or reduce the need for error correction.

Steps 416 are performed responsive to steps 408, 410, 412, and 414. During steps 416, respective electric fields are applied to each E-O waveguide of the TFPS by respective high speed electrodes in cooperation with corresponding ground electrodes. The applied electric fields cause respective shifts in electron distribution along poled chromophores, as described above, to momentarily hyperpolarize or depolarize the chromophores, depending on the direction of each electric field relative to chromophore polarity. The changes in electron distribution result in corresponding changes in refractive index which are exhibited as changes in propagation velocity of the TM polarized coherent light passing through the E-O waveguides. The changes in light propagation velocity result in respective phase shifts of the light emerging from the output ends of the E-O waveguides.

Responsive to whether or not an electric field is applied to a given E-O waveguide, light may be output from an E-O waveguide at a relative phase shift of 0 (zero), +π/2, or −π/2, compared to the phase of light entering the E-O waveguide (core). This may, for example, be superimposed over a nominal π phase offset between a waveguide pair (e.g., between E-O waveguide 110a and E-O waveguide 110b) or a nominal 0 (zero) phase offset between a waveguide pair. A nominal IF phase offset may be produced by one or more of a propagation distance difference of light passed through the waveguide and/or a T-O phase offset. The propagation distance difference may be imposed by adding distance to the input interface waveguide 106, the output interface waveguide 114, the E-O waveguide 110, or by adding another active or passive phase shifter.

For purposes of description, it will be assumed there is a nominal 0 (zero) phase offset between a waveguide pair 110a, 110b. Applying a phase shift of 0 (zero) to the waveguides of the pair (e.g. by applying zero voltage to the high speed electrode) maintains the 0 (zero) phase offset of the light passing therethrough, which results in constructive interference when the light is recombined. Constructive interference results in little to substantially no attenuation of light being output from a M-Z interferometer 152a. Conversely, applying a phase shift of +π/2 to one E-O waveguide 110a and a phase shift of −π/2 to a paired E-O waveguide 110b (by applying corresponding voltages to the respective high speed electrodes) results in the light emerging from the waveguides 110a, 110b being at or about π radians out of phase. The phase inversion results in destructive interference when the light from the waveguides 110a, 110b is combined, which corresponds to large to substantially 100% attenuation of the combined light. The simultaneous application of complementary ±π/2 phase shifts to a pair of E-O waveguides that form a portion of a MZ interferometer may be referred to as push/pull or push-pull operation. Push-pull operation may result in lower voltage operation and/or a reduction of required E-O waveguide length compared to applying a modulating voltage to only one of a pair of waveguides. For a given E-O waveguide pair and set of operating conditions (e.g., modulation depth, which may involve modulation to somewhat less than a full ±π/2), the voltage required to drive the E-O waveguides from in-phase to out-of-phase (or the converse) may be referred to as Vπ, V_{π}, or Vpi.

Proceeding to step 418, light from the TFPS E-O modulation waveguides (FIG. 1, 110a-h) is received by output interface waveguides (FIG. 1 114a-h) on the output PLC 112. Step 418 may include launching the light from an edge facet (FIGS. 1, 2A, 2B 122) formed through the optical polymer stack (FIG. 3, 303). For example, the facet in the thin film polymer may include an edge facet formed by dicing a substrate and polymer film of the TFPS die; or by scoring the substrate, cracking the substrate, and propagating the crack through the optical polymer stack.

Proceeding to step 420, light from push-pull pairs of E-O modulator waveguides (FIG. 1, 110a-h) is combined. In step 420, light from the first pair of E-O modulator waveguides (FIG. 1, 110a, 110b) is combined to form a first MZ interferometer modulated light data signal. Light from a second pair of E-O modulator waveguides (FIG. 1, 110c, 110d) is combined to form a second MZ interferometer modulated light data signal. Light from a third pair of E-O modulator waveguides (FIG. 1, 110e, 110f) is combined to form a third MZ interferometer modulated light data signal. And light from a fourth pair of E-O modulator waveguides (FIG. 1, 110g, 110h) is combined to form a fourth MZ interferometer modulated light data signal. The first, second, third, and fourth MZ interferometer modulated light data signals respectively carry first sine-modulated, first cosine-modulated, second sine-modulated, and second cosine-modulated light.

Proceeding to step 422, light from the first pair of E-O modulator waveguides (FIG. 1, 110a, 110b) and the first MZ interferometer (FIG. 1, 152a) is combined with light from the second pair of E-O modulator waveguides (FIG. 1, 110c, 110d) and the second MZ interferometer (FIG. 1, 152c) to produce a first quadrature-modulated light data signal.

Step 424 (which may be performed in parallel with step 422) includes combining the light from the third pair of E-O modulator waveguides (FIG. 1, 110e, 110f) and the third MZ interferometer (FIG. 1, 152e) with light from the fourth pair of E-O modulator waveguides (FIG. 1, 110g, 110h) and the fourth MZ interferometer (FIG. 1, 152g) to produce a second quadrature-modulated light data signal.

In step 426, the polarization plane of the modulated light from the first and second pair of E-O modulator waveguides (FIGS. 1, 110a, 110b, 110c, and 110d) is rotated. For example, the polarization may be rotated from TM-plane polarization to TE-plane polarization. According to an embodiment, step 426 may be performed on light after the combination step 422. For example, rotating the polarization plane of the modulated light from the first and second pair of E-O modulator waveguides from TM-plane polarization to TE-plane polarization may include passing a quadrature modulated light signal through a polarization rotator (FIGS. 1, 2A, 134) disposed on the output PLC (FIGS. 1, 2A, 112) or disposed between portions of the output PLC. The polarization rotator may, for example, be formed from a half-wave plate. The polarization rotator may be inserted into a groove in the output PLC (FIGS. 1, 2A, 112). Alternatively, the output PLC (FIGS. 1, 2A, 112) may be formed from two separate dice, and the polarization rotator may be disposed between the separate output PLC dice.) Alternatively, step 426 may be performed at one or more different orders. For example, in a method 401 corresponding to the device configuration illustrated in FIG. 2B, step 426 may be performed before or during steps 418. In another embodiment, step 426 may be performed before or during steps 420, or before or during step 422. For example, rotating the polarization plane of the modulated light from the first and second pair of E-O modulator waveguides from TM-plane polarization to TE-plane polarization may include passing phase modulated light from a portion of the TFPS E-O modulator waveguides (FIG. 1, 110a-110d) through a polarization rotator (FIGS. 1, 2B, 134′) before the light is received by the output PLC (FIGS. 1, 2A, 112).

Proceeding to step 428, the light from the first quadrature-modulated light data signal is combined with light from the second quadrature-modulated light data signal to produce an output modulated light wavelength data signal including a quadrature-modulated TE-plane polarized light component and a quadrature-modulated TM-plane polarized light component.

The method 401 may further include receiving a plurality of MZ bias signals and heating at least a portion of half of the E-O modulation waveguides (FIG. 1, 110a, 110c, 110e, 110g) to tune each MZ interferometer (FIG. 1,152a, 152c, 152e, 152g) waveguide pair to a V_{π} (step not shown). As described above, applying the MZ bias signals may be performed on the TFPS die 108. For example, a current may be passed through the ground electrode (FIG. 3, 302) to provide heating. Approaches for superimposing T-O bias over E-O modulation using the same electrode is described in U.S. Pat. No. 7,738,745, issued Jun. 15, 2010 to the Applicant, which is, to the extent not inconsistent with the disclosure herein, incorporated by reference. Alternatively, one or more separate heater electrode(s) may be placed below, above, to one side, or to both sides of the biased E-O waveguides (FIG. 1, 110a, 110c, 110e, 110g). Alternatively, all the E-O modulation waveguides (FIG. 1, 110a-h) may be heated differentially to provide T-O MZ bias.

Alternatively, MZ bias may be provided by heater electrodes included on the input PLC (FIG. 1, 102) and/or the output PLC (FIG. 1, 112). While this may be readily implemented, it was found to require a higher amount of thermal energy, and hence higher power consumption than providing MZ bias on the TFPS die.

Alternatively, it is contemplated that an E-O DC bias voltage could be substituted for T-O bias. However, the inherently fast response time and low voltage requirements of hyperpolarizable chromophores described herein make them susceptible to even minute amounts of voltage ripple, which has heretofore made E-O bias difficult.

The method 401 may further include receiving a plurality of quadrature bias signals and heating a portion of the input PLC waveguides or the output PLC waveguides to bring MZ interferometers in quadrature with one another (FIG. 1,152a and 152c; and FIGS. 1, 152e and 152g) into coherent light phase alignment. For example, a current may be passed through a heater electrode of quadrature bias devices (FIG. 1, 156a, 156e) to provide heating and a corresponding T-O phase shift.

The method 401 may further include receiving a polarization bias signal and heating an input PLC waveguide or an output PLC waveguide to phase or temporally align the TE-plane polarized light component with the TM-plane polarized light component. For example, a current may be passed through a heater electrode of a phase bias device (FIG. 1, 158) to provide heating and a corresponding T-O phase shift.

Optionally, the method 401 may include generating the sine data and the cosine data for modulating the E-O modulators (not shown). According to embodiments, generating the sine data and the cosine data may include generating quadrature amplitude modulated (QAM), quadrature phase shift keying (QPSK), or differential quadrature phase shift keying (DQPSK) modulated electrical signals.

According to an alternative embodiment, the method 401 may omit quadrature modulation. For example, steps 412 and 414 (and corresponding splitting, modulation, and combining steps) may be omitted, and steps 408 and 410 may be rephrased as “receive data”. Accordingly, the method 401 may include generating data such as generating phase shift keying (PSK) or differential phase shift keying (DPSK) data.

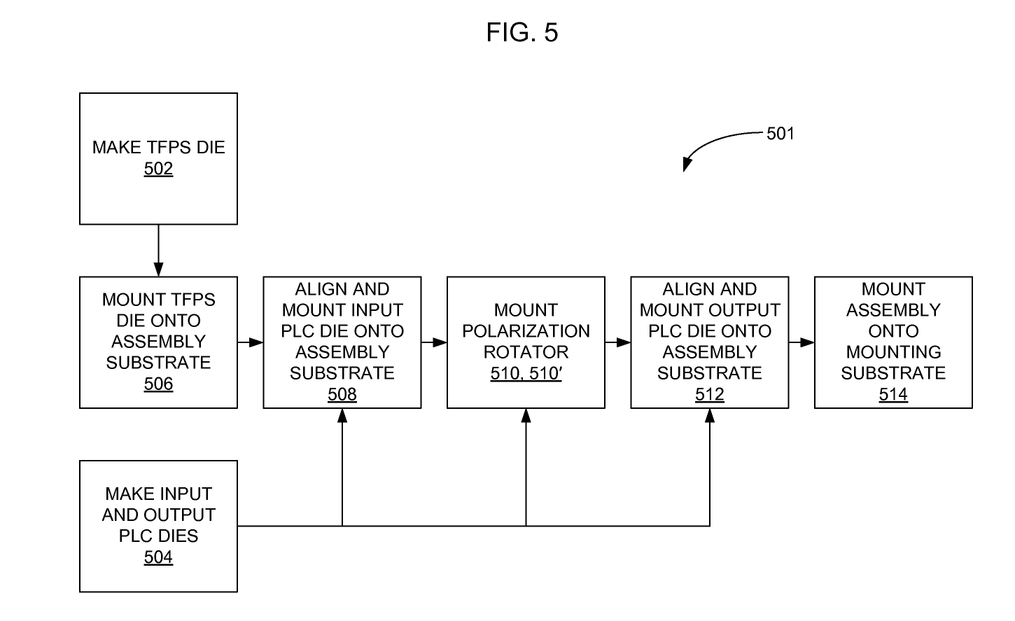

FIG. 5 is a flow chart showing a method 501 for making the dual polarization quadrature modulator of FIGS. 1-3, according to an embodiment.

In step 502, a TFPS modulator die may be made. Alternatively, the TFPS modulator die may be purchased. In step 502, a TFPS substrate may be provided or formed. For example, the substrate may include a semiconductor such as silicon, may include an insulator such as glass, may include a flexible polymer such as polyimide (e.g., Kapton), poly-ether-ether-ketone (PEEK), or polyester terapthalate (PET), or may include a combination of materials. The substrate may include circuitry and/or a conductor layer. The conductor layer may be selectively etched to form ground electrodes and/or T-O bias devices. The substrate may optionally be planarized. Optionally, providing or forming the substrate may include forming a ground electrode. For example, the surface of the substrate may be sputtered, for example with gold or aluminum, and etched to form a patterned seed layer. The patterned seed layer may then be plated to a desired thickness.

Next, at least a portion of an optical polymer stack may be applied onto the substrate, for example by spin coating a thermoplastic, a gel, or a heat-set polymer. The bottom cladding layer may include, for example, a polymer, an electro-optic polymer with a lower refractive index than the electro-optic polymer layer, an organic-inorganic hybrid, an inorganic material, or a combination thereof. The bottom cladding may be cooled, gelled, and/or cross-linked to solidify the bottom cladding. Light guiding structures may be formed in the bottom cladding by patterned etching. The light guiding structures may include an optical waveguide in the form of a trench, a side clad, a channel, a rib, a quasi trench, or a quasi rib.

Next, an E-O polymer may be applied over the bottom cladding, for example by spin coating. The E-O polymer may include a guest-host system including a host polymer and a guest chromophore. Example compositions of E-O polymers are described above. The E-O polymer may flow over the surface of and into any formed structures in the bottom cladding. Typically, the E-O polymer includes chromophores at random orientations when applied to the bottom cladding. A top cladding layer and a poling electrode may be formed over the E-O layer. Next, at least portions of the second order non-linear optical chromophores in the electro-optic polymer adjacent to the electrodes are poled and cured to substantially fix the alignment of the chromophores in the electro-optic polymer layer in their poled orientation. For example, the assembly may be raised to a temperature of approximately 140 degrees C. while a poling voltage of about 400 to 1100 volts is held across the electro-optic polymer layer. According to some embodiments, the poling voltage may be about 600-1000 volts. The temperature may be maintained for a few seconds before cooling down with the voltage holding the poled orientation of the chromophore molecules while a host polymer is cross-linked to “trap” the chromophores in their poled orientation. Alternatively, a UV or other radiation cured host polymer may be used and curing may include application of cross-linking radiation instead of or in addition to the application of heat. Alternatively, the chromophores themselves may include cross-linking portions and the chromophores may covalently bond to a host polymer and/or to one another to maintain orientation. Alternatively, the host polymer may be fully linked, and curing can include simply lowering the temperature to below the glass transition temperature, T_{g}, of the electro-optic polymer.

Typically, the poling temperature is within ±15° C. of the glass transition temperature (T_{g}) of the electro-optic polymer layer; but the poling temperature may be another temperature at which the chromophores are mobile enough for alignment at a given poling field voltage. Further maintenance of the poling temperature may be sufficient to induce curing. Alternatively, the temperature may be raised or lowered to allow curing to progress. The poling electrode may be stripped, or optionally a high speed modulation electrode may be used as the poling electrode.

A polymer top cladding layer may be formed over the E-O polymer layer above or below the poling and/or high speed electrode. For example, the top cladding layer may be formed from photo-cross-linkable epoxies or a photo-cross-linkable acrylates that are spin coated or otherwise applied over the E-O polymer layer. The thickness of the high speed electrode, top cladding, E-O polymer layer, and or bottom clad etch depth may be selected to meet dimensions illustratively given above in conjunction with FIG. 3. Alternatively or additionally, the thickness of the high speed electrode, top cladding, E-O polymer layer, and or bottom clad etch depth may be selected to meet a PLC waveguide vertical location such that, when assembled, the input interface waveguides, E-O waveguides, and output interface waveguides are aligned vertically as illustrated in FIG. 3.

According to an embodiment, step 502 may include dicing the TFPS die from a TFPS wafer such that input and output facets of the E-O modulator waveguides are formed by dicing through the polymer and substrate. According to another embodiment, step 502 may include scoring the TFPS wafer, and propagating cracks across the polymer stack.

In step 504, input and output PLCs may be made. Alternatively one or both of the input and output PLCs may be purchased. Forming the input and output PLCs may include, for example, providing a substrate such as a glass or silicon substrate, optionally forming a layer of SiO₂ on the surface of the substrate, and photolithographically forming waveguides, for example by nitriding or another process selected to increase the refractive index in waveguide cores along selected light propagation paths. Following waveguide core formation, another layer such as SiO₂ or another polymer, inorganic, or hybrid top cladding may be formed on the surface of the PLCs over the waveguide cores. The thickness of the PLC top cladding and/or waveguide core depth may be selected to match a surface-to-core distance of the E-O waveguides in the TFPS die.

Optionally, forming the output PLC may include forming a groove in the output PLC die at a location corresponding to one or more waveguides configured to carry light after passing through a first portion of the E-O modulation waveguides. Step 510 may then include mounting a polarization rotator in the groove. That is, forming the groove and mounting the polarization rotator in the output PLC may be performed prior to mounting the output PLC die onto the assembly substrate in step 512. Optionally, the output PLC die may include two output PLC dice formed to accept a polarization rotator between the two output PLC dice.

Proceeding to step 506, the TFPS modulator die may be mounted on an assembly substrate. The TFPS modulator die including a plurality of E-O modulation waveguides is mounted onto the assembly substrate such that the optical polymer stack and the E-O modulation waveguides are adjacent to the assembly substrate and the TFPS substrate is spaced away from the assembly substrate by the polymer stack. For example, the TFPS modulator die may be mounted by adhering the top of the optical polymer stack to the assembly substrate using an adhesive, such as an optical adhesive. The adhesive may include a UV-cured optical adhesive.

Optionally, the assembly substrate may include a plurality of high speed electrodes corresponding to the E-O modulator waveguides. Mounting the TFPS die onto the assembly substrate may include aligning the E-O modulator waveguides to the high speed electrodes. According to an alternative embodiment, the high speed electrodes may be formed over the optical polymer stack. In such an alternative embodiment, mounting the TFPS die onto the assembly substrate may include aligning the E-O modulator waveguides to a nominal or desired position relative to the assembly substrate.

Proceeding to step 508, an input PLC die may be mounted on the assembly substrate. The input PLC die may include a plurality of input interface waveguides in a waveguide layer on a PLC substrate. The input PLC die may be mounted onto the assembly substrate while aligning the plurality of input interface waveguides to the input ends of the E-O modulation waveguides of the TFPS die. According to an embodiment, the input PLC die may be mounted on the assembly substrate such that the input PLC waveguide layer is adjacent to the assembly substrate and the PLC substrate is spaced away from the assembly substrate by the input PLC waveguide layer. For example, the input PLC die may be mounted by adhering the top of the waveguide layer to the assembly substrate using an adhesive, such as an optical adhesive. The adhesive may include a UV-cured optical adhesive.

In step 510, a polarization rotator may be mounted on an output PLC die or alternatively, on the assembly substrate. For example, step 510 may include mounting a polarization rotator in a groove in the PLC die.

Optionally, a first portion of step 512 may be performed before step 510, and a second portion of step 512 may be performed after step 510. For example, mounting the polarization rotator may include mounting the polarization rotator between two output PLC dice at a location corresponding to one or more waveguides configured to carry light after passing through a first portion of the E-O modulator waveguides. Accordingly, step 512 may include first mounting a first output PLC die including output interface waveguides in alignment with the E-O waveguides of the TFPS die and a quadrature modulator output waveguide (FIG. 1, 156a), and after performing step 510, then mounting a second output PLC die including an input waveguide (FIG. 1, 156a) in alignment with the quadrature modulator output waveguide (FIG. 1, 156a) of the first output PLC die and adjacent to the polarization rotator.

In alternative step 510′, the polarization rotator is mounted onto the assembly substrate before performing step 512. For example, the polarization rotator may be mounted adjacent to the output ends of a first portion of the E-O modulator waveguides. For example, the polarization rotator may be mounted by adhering the polarization rotator to the assembly substrate and/or the TFPS die using an adhesive, such as an optical adhesive. The adhesive may include a UV-cured optical adhesive. Optionally, step 510′ may include mounting a non-polarization-rotating window having substantially the same thickness as the polarization rotator adjacent to the output ends of a second portion of the E-O modulator waveguides not subtended by the polarization rotator. This may be used, for example, to keep the numerical apertures corresponding to the TFPS to output PLC constant between the first polarization quadrature modulator (FIG. 1, 154a) and the second polarization quadrature modulator (FIG. 1, 154e).

Proceeding to step 512, an output PLC die is mounted on the assembly substrate. The output PLC die may include a plurality of output interface waveguides in a waveguide layer on a PLC substrate. The output PLC may be mounted onto the assembly substrate while aligning the plurality of output interface waveguides to the output ends of the E-O modulation waveguides of the TFPS such that the output PLC waveguide layer is adjacent to the assembly substrate and the output PLC substrate is spaced away from the assembly substrate by the output PLC waveguide layer. For example, the output PLC die may be mounted by adhering the top of the waveguide layer to the assembly substrate using an adhesive, such as an optical adhesive. The adhesive may include a UV-cured optical adhesive.

Optionally, mounting the output PLC die in step 512 may include mounting the output PLC die adjacent to the polarization rotator, such as in a location corresponding to that shown in FIG. 2B.

Proceeding to step 514, the assembled assembly substrate, input PLC die, TFPS die, and output PLC die may be mounted onto a mounting substrate such that the input PLC die, TFPS die, and output PLC die are adjacent to the mounting substrate and the assembly substrate is spaced away from the mounting substrate by the respective input PLC, TFPS, and output PLC substrates and waveguide layers. Optionally, mounting the assembled assembly substrate, input PLC die, TFPS die, and output PLC die onto a mounting substrate may include placing a thermal gasket or thermal gel between the respective input PLC die, TFPS die, and output PLC die substrates and the mounting substrate.

As an alternative to mounting the input PLC die, TFPS die, and output PLC die or dice with their waveguide surfaces against the assembly substrate, the PLC dice and TFPS die may be mounted with their respective substrates against the assembly substrate, and their waveguide surfaces spaced away from the assembly substrate by their respective substrates. In such an embodiment, the mounting substrate and the assembly substrate may be the same substrate. In this embodiment, the individual PLC and TFPS substrates should have matched thicknesses to provide vertical alignment between the TFPS E-O waveguides and the respective PLC input interface and output interface waveguides.

Optionally, the input PLC input interface waveguides, the TFPS E-O waveguides, and the output PLC output interface waveguides may be formed with tapers or core dimensions configured to receive light while allowing for some amount of optical misalignment across the respective dice. For example, respective numerical apertures may be selected to cause receipt of substantially all light launched across the die optical interfaces.

According to alternative embodiments, the combination of TFPS and PLC components may be used according to the description provided herein to construct hybrid devices other than dual polarization optical modulators such as the phase shift keying devices explicitly described.

According to embodiments, a hybrid optical modulator may be structured and/or driven to output optical signals having other modulation schemas. For example, the hybrid optical modulator may be structured and/or driven with a multilevel modulation format such as DQPSK, RZ-DQPSK, 64QAM, and/or other selectable multilevel modulator.

According to embodiments, the input and/or output PLCs may include waveguide structures to provide multiplexing and/or demultiplexing. Optionally the input and/or output PLC may be configured to couple to or may include one or more waveguides integrated with one or more lasers and/or one or more detectors. The one or more detectors may include amplifiers such as transimpedance amplifiers.

The descriptions and figures presented herein are necessarily simplified to foster ease of understanding. While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. An optical modulator, comprising:
an input planar lightwave circuit (PLC) configured to divide and deliver coherent light through a plurality of input interface waveguides;
a thin film polymer on substrate (TFPS) modulator including a plurality of electro-optic (E-O) polymer waveguides, each respectively operatively coupled to receive the divided coherent light from each of at least a portion of the plurality of input interface waveguides, at least a portion of E-O polymer waveguides being configured to modulate the received coherent light; and
an output planar lightwave circuit including a plurality of output interface waveguides, at least a portion of which are operatively coupled to receive modulated light from the plurality of electro-optic polymer waveguides, the output planar lightwave circuit being configured to combine the received modulated light into at least one output waveguide.

2. The optical modulator of claim 1, wherein the thin film polymer on substrate modulator includes a plurality of first phase bias devices operatively coupled to at least a portion of the plurality of electro-optic polymer waveguides.

3. The optical modulator of claim 2, wherein the plurality of first phase bias devices include first thermo-optic (T-O) phase bias devices configured to modify a refractive index of a portion of the electro-optic polymer waveguide corresponding thereto.

4. The optical modulator of claim 1, wherein the electro-optic polymer waveguides of the thin film polymer on substrate modulator each include a light input facet and a light output facet formed by scoring a substrate and propagating a crack across the substrate and the thin film polymer.

5. The optical modulator of claim 1, wherein the coherent light delivered through the plurality of input interface waveguides to the thin film polymer on substrate is substantially TM plane polarized;
wherein TM plane polarized light includes an electrical transverse wave oriented 90 degrees from surface planes of the input planar lightwave circuit, the thin film polymer on substrate modulator, and the output planar lightwave circuit.

6. The optical modulator of claim 1, further comprising:
a TM plane polarizer included in or operatively coupled to the input planar lightwave circuit.

7. The optical modulator of claim 1, wherein the input planar lightwave circuit further comprises:
an input waveguide; and
a plurality of input interface waveguide splitters configured to split input coherent light from the input waveguide to deliver coherent light to each of the input interface waveguides.

8. The optical modulator of claim 1, further comprising:
a polarization rotator operatively coupled to a first portion of the electro-optic polymer waveguides, the polarization rotator being configured to rotate the TM modulated light from the first portion of the electro-optic polymer waveguides to TE plane polarized light;
wherein TE plane plane polarized light includes an electrical transverse wave oriented parallel to the surface planes of the input planar lightwave circuit, the thin film polymer on substrate modulator, and the output planar lightwave circuit.

9. The optical modulator of claim 8, wherein the output planar lightwave circuit further comprises:
an optical combiner operatively coupled to the first portion of the electro-optic polymer waveguides and a second portion of the electro-optic polymer waveguides, and configured to combine the TE plane polarized light from the first portion of the electro-optic polymer waveguides and the polarization rotator with TM plane polarized light from the second portion of the electro-optic polymer waveguides; and
an output waveguide operatively coupled to the optical combiner and configured to carry the combined TE and TM plane polarized light.

10. The optical modulator of claim 9, further comprising:
an output optical coupler operatively coupled to the output waveguide and configured to couple the combined TE and TM plane polarized light to an optical fiber or another waveguide device.

11. The optical modulator of claim 1, further comprising:
an assembly substrate; and
wherein the input planar lightwave circuit, the thin film polymer on substrate modulator, and the output planar lightwave circuit are mounted on the assembly substrate with their respective waveguides adjacent to the assembly substrate and the individual substrates mounted away from the assembly substrate.

12. The optical modulator of claim 11, wherein the assembly substrate is configured to provide vertical alignment between the waveguides of the thin film polymer on substrate modulator and the input and output planar lightwave circuits.

13. The optical modulator of claim 11, wherein the assembly substrate comprises:
a substantially 1 millimeter thick glass slide.

14. The optical modulator of claim 1, further comprising:
a first Mach-Zehnder interferometer, the first Mach-Zehnder interferometer including, on the input planar lightwave circuit:
a first input intermediate waveguide;
two first input interface waveguides; and
a first input splitter operatively coupled to the first intermediate waveguide and configured to split coherent light received from the first input intermediate waveguide onto the two first input interface waveguides;
the first Mach-Zehnder interferometer further including, on the thin film polymer on substrate modulator:
a first pair of electro-optic polymer waveguide modulation channels respectively aligned to receive coherent light from the two first input interface waveguides; and
the first Mach-Zehnder interferometer further including, on the output planar lightwave circuit:
two first output interface waveguides aligned to receive modulated coherent light from the first pair electro-optic polymer waveguide modulation channels;
a first output combiner operatively coupled to the two first output interface waveguides configured to combine the received light; and
a first output intermediate waveguide configured to receive the combined light from the first output combiner.

15. The optical modulator of claim 14, further comprising:
a second Mach-Zehnder interferometer, the second Mach-Zehnder interferometer including, on the input planar lightwave circuit:
a second input intermediate waveguide;
two second input interface waveguides; and
a second input splitter operatively coupled to the second intermediate waveguide and configured to split coherent light received from the second input intermediate waveguide onto the two second input interface waveguides;
the second Mach-Zehnder interferometer further including, on the thin film polymer on substrate modulator:
a second pair of electro-optic polymer waveguide modulation channels respectively aligned to receive coherent light from the two second input interface waveguides; and
the second Mach-Zehnder interferometer further including, on the output planar lightwave circuit:
two second output interface waveguides aligned to receive modulated coherent light from the first pair electro-optic polymer waveguide modulation channels;
a second output combiner operatively coupled to the two second output interface waveguides configured to combine the received light; and
a second output intermediate waveguide configured to receive the combined light from the second output combiner.

16. The optical modulator of claim 15, wherein the first and second Mach-Zehnder interferometers are configured to cooperate to form a first quadrature phase shift keying (QPSK) or differential quadrature phase shift keying (DQPSK) light modulator.

17. The optical modulator of claim 16, further comprising:
a thermo-optic quadrature phase bias device disposed on the input planar lightwave circuit or the output planar lightwave circuit, operatively coupled to one of the first or the second Mach-Zehnder interferometer, and configured to maintain a sine-cosine phase relationship between the first and second Mach-Zehnder interferometers to keep the quadrature phase shift keying or quadrature differential phase shift keying light modulator substantially in proper phase alignment.

18. The optical modulator of claim 17, further comprising:
third and fourth Mach-Zehnder interferometers formed on the input planar lightwave circuit, thin film polymer on substrate modulator, and output planar lightwave circuit, and configured as a second quadrature phase shift keying or quadrature differential phase shift keying light modulator operable to modulate the coherent light.

19. The optical modulator of claim 18, further comprising:
a polarization rotator operatively coupled to an output waveguide of the first quadrature phase shift keying or quadrature differential phase shift keying light modulator and configured to rotate the polarization of the first quadrature phase shift keying or quadrature differential phase shift keying modulated coherent light from TM to TE plane polarization; and
a combiner configured to combine the TE plane polarized light from the first quadrature phase shift keying or quadrature differential phase shift keying light modulator with TM plane polarized light from the second quadrature phase shift keying or quadrature differential phase shift keying light modulator to form a single light signal on an output waveguide including two separable quadrature phase shift keying or quadrature differential phase shift keying modulated light signals.

20. The optical modulator of claim 19, further comprising:
a polarization phase bias device configured to shift the phase of light from the first or the second quadrature phase shift keying or quadrature differential phase shift keying light modulator to match the phase of the other quadrature phase shift keying or quadrature differential phase shift keying light modulator.

21. The optical light modulator of claim 1, wherein the thin film polymer on substrate modulator includes a respective high speed electrode operatively coupled to each electro-optic modulation waveguide.

22. The optical modulator of claim 1, wherein the coherent light consists essentially of a single wavelength.

23. The optical modulator of claim 1, wherein the coherent light includes one of a plurality of wavelength division multiplexed (WDM) channels selected from a C or L data transmission wavelength division multiplexed band.

24. The optical modulator of claim 1, further comprising:
a polarization rotator mounted between the thin film polymer on substrate modulator and the output planar lightwave circuit in a region corresponding to a portion of the electro-optic polymer waveguides, configured to rotate TM plane polarized light received from the portion of the electro-optic polymer waveguides to TE plane polarized light.

25. The optical modulator of claim 1, wherein the waveguides of the input planar lightwave circuit, the electro-optic modulation waveguides of the thin film polymer on substrate modulator, and the waveguides of the output planar lightwave circuit are each formed in respective waveguide layers adjacent to top surfaces on respective substrates, and are held in mutual alignment in a Z-axis by mounting the waveguide layers adjacent to the assembly substrate.

26. The optical modulator of claim 1, further comprising:
a mounting substrate configured to carry the input planar lightwave circuit, the thin film polymer on substrate modulator, the output planar lightwave circuit, and an assembly substrate; and configured to carry the dual polarization quadrature light modulator for operative coupling to at least one of a package, a heat sink, or to one or more additional waveguide devices.

27. The optical modulator of claim 26, further comprising:
a thermal gasket or thermal gel configured to thermally couple at least the thin film polymer on substrate light modulator to the mounting substrate.

28. The optical modulator of claim 1, wherein the input planar lightwave circuit, thin film polymer on substrate modulator, and output planar light wave circuit are configured to cooperate to operate as one or more of a dual polarization quadrature light modulator, a quadrature phase shift keying (QPSK) light modulator, a differential phase shift keying (DPSK) light modulator, differential quadrature phase shift keying (DQPSK) light modulator, a return-to-zero differential quadrature phase shift keying (RZ-DQPSK) light modulator, a quadrature amplitude modulator (QAM), or a multilevel optical modulator.

29. The optical modulator of claim 1, wherein the electro-optic polymer waveguides of the thin film polymer on substrate modulator each include a light input facet and a light output facet formed by dicing the substrate and thin film polymer with a dicing saw.

30. The optical modulator of claim 1, wherein the input planar lightwave circuit further comprises:
one or more of a multimode interference (MMI) coupler, a directional coupler, a multiplexing section, or a demultiplexing section.

31. The optical modulator of claim 1, wherein the input planar lightwave circuit further comprises:
a laser configured to generate the coherent light

32. The optical modulator of claim 1, wherein the output planar lightwave circuit further comprises:
one or more of a multimode interference (MMI) coupler, a directional coupler, a multiplexing section, or a demultiplexing section.

33. The optical modulator of claim 1, wherein the output planar lightwave circuit further comprises:
one or more photodetectors.

34. A method for modulating data onto a light wavelength with a dual polarization quadrature light modulator, comprising:
receiving coherent TM-plane polarized light;
splitting the coherent light into eight input interface waveguides with an input planar lightwave circuit;
receiving the coherent light from the eight input interface waveguides and transmitting eight respective channels of coherent light through eight respective thin film polymer on substrate electro-optic modulator waveguides;
receiving at least one first and at least one second modulated electrical sine data signals onto at least one first and at least one second respective high speed sine electrodes, the at least one first high speed sine electrode being operatively coupled to a first pair of the electro-optic modulator waveguides, and the at least one second high speed sine electrode being operatively coupled to a third pair of the electro-optic modulator waveguides;
receiving at least one first and at least one second modulated electrical cosine data signals onto at least one first and at least one second respective high speed cosine electrodes, the at least one first high speed cosine electrode being operatively coupled to a second pair of the electro-optic modulator waveguides, and the at least one second high speed cosine electrode being operatively coupled to a fourth pair of the electro-optic modulator waveguides;
wherein the first sine and first cosine modulated electrical data signals are substantially in quadrature, and the second sine and second cosine modulated electrical data signals are substantially in quadrature;
applying electrical fields produced by the respective high speed electrodes to eight electro-optic modulator waveguides to cause eight respective phase shifts in the coherent TM-plane polarized light passing therethrough;
receiving the phase shifted coherent polarized light with eight output interface waveguides with an output planar lightwave circuit;
combining the light from the first pair of electro-optic modulator waveguides, combining the light from the second pair of electro-optic modulator waveguides, combining the light from the third pair of electro-optic modulator waveguides, and combining the light from the fourth pair of electro-optic modulator waveguides to form respective first, second, third, and fourth Mach-Zehnder interferometer modulated light data signals respectively carrying first sine-modulated, first cosine-modulated, second sine-modulated, and second cosine-modulated light;
combining the light from the first pair of electro-optic modulator waveguides and the first Mach-Zehnder interferometer with light from the second pair of electro-optic modulator waveguides and the second Mach-Zehnder interferometer to produce a first quadrature-modulated light data signal;
combining the light from the third pair of electro-optic modulator waveguides and the third Mach-Zehnder interferometer with light from the fourth pair of electro-optic modulator waveguides and the fourth Mach-Zehnder interferometer to produce a second quadrature-modulated light data signal;
rotating the polarization plane of the modulated light from the first and second pair of electro-optic modulator waveguides from TM-plane polarization to TE-plane polarization; and
combining the light from the first quadrature-modulated light data signal with light from the second quadrature-modulated light data signal to produce an output modulated light wavelength data signal including a quadrature-modulated TE-plane polarized light component and a quadrature-modulated TM-plane polarized light component.

35. The method for modulating data onto a light wavelength with a dual polarization quadrature light modulator of claim 34, further comprising:
receiving a plurality of Mach-Zehnder bias signals; and
heating a portion of half of the electro-optic modulation waveguides to tune each Mach-Zehnder interferometer waveguide pair to a V_{π}.

36. The method for modulating data onto a light wavelength with a dual polarization quadrature light modulator of claim 34, further comprising:
receiving a plurality of quadrature bias signals; and
heating a portion of the input planar lightwave circuit waveguides or the output planar lightwave circuit waveguides to bring Mach-Zehnder interferometers in quadrature with one another into coherent light phase alignment.

37. The method for modulating data onto a light wavelength with a dual polarization quadrature light modulator of claim 34, further comprising:
receiving a polarization bias signal; and
heating an input planar lightwave circuit waveguide or an output planar lightwave circuit waveguide to temporally or phase align the TE-plane polarized light component with the TM-plane polarized light component.

38. The method for modulating data onto a light wavelength with a dual polarization quadrature light modulator of claim 34, wherein receiving the coherent light from the eight input interface waveguides and transmitting eight respective channels of coherent light through eight respective thin film polymer on substrate electro-optic modulator waveguides includes receiving light through an edge facet in the thin film polymer formed by dicing the substrate and the thin film polymer from a wafer with a dicing saw.

39. The method for modulating data onto a light wavelength with a dual polarization quadrature light modulator of claim 34, wherein receiving the phase shifted coherent polarized light with eight output interface waveguides with an output planar lightwave circuit includes launching light through an edge facet in the thin film polymer formed by dicing the substrate and the thin film polymer from a wafer with a dicing saw.

40. The method for modulating data onto a light wavelength with a dual polarization quadrature light modulator of claim 34, wherein rotating the polarization plane of the modulated light from the first and second pair of electro-optic modulator waveguides from TM-plane polarization to TE-plane polarization includes passing a quadrature modulated light signal through a polarization rotator disposed on the output planar lightwave circuit or disposed between portions of the output planar lightwave circuit.

41. The method for modulating data onto a light wavelength with a dual polarization quadrature light modulator of claim 34, wherein rotating the polarization plane of the modulated light from the first and second pair of electro-optic modulator waveguides from TM-plane polarization to TE-plane polarization includes passing phase modulated light from a portion of the thin film polymer on substrate electro-optic modulator waveguides through a polarization rotator before the light is received by the output planar lightwave circuit.

42. The method for modulating data onto a light wavelength with a dual polarization quadrature light modulator of claim 34, further comprising:
polarizing received coherent light to TM-plane polarized.

43. The method for modulating data onto a light wavelength with a dual polarization quadrature light modulator of claim 34, wherein receiving the coherent light includes receiving a first channel of coherent light corresponding to a first quadrature modulator and receiving a second channel of coherent light corresponding to a second quadrature modulator;
wherein the first and second channels of coherent light are incoherent with each other.

44. The method for modulating data onto a light wavelength with a dual polarization quadrature light modulator of claim 34, further comprising:
generating the sine data and the cosine data for modulating the electro-optic modulators.

45. The method for modulating data onto a light wavelength with a dual polarization quadrature light modulator of claim 34, wherein receiving at least one first sine and at least one first cosine modulated electrical signals includes receiving quadrature amplitude modulation (QAM), quadrature phase shift keying (QPSK), or differential quadrature phase shift keying (DQPSK) modulation.

46. The method for modulating data onto a light wavelength with a dual polarization quadrature light modulator of claim 34, wherein receiving at least one first sine and at least one first cosine modulated electrical signals includes receiving differential phase shift keying (DPSK) modulation.

47. The method for modulating data onto a light wavelength with a dual polarization quadrature light modulator of claim 34, wherein receiving the coherent light from the eight input interface waveguides and transmitting eight respective channels of coherent light through eight respective thin film polymer on substrate electro-optic modulator waveguides includes receiving light through an edge facet in the thin film polymer formed by scoring the substrate of the thin film polymer on substrate, and propagating a crack across the substrate and the thin film polymer.

48. The method for modulating data onto a light wavelength with a dual polarization quadrature light modulator of claim 34, wherein receiving the phase shifted coherent polarized light with eight output interface waveguides with an output planar lightwave circuit includes launching light through an edge facet in the thin film polymer formed by scoring the substrate of the thin film polymer on substrate, and propagating a crack across the substrate and the thin film polymer.

49. A method for making a dual polarization quadrature light modulator, comprising:
mounting a thin film polymer on substrate modulator die, the thin film polymer on substrate modulator die including a plurality of electro-optic modulation waveguides including input ends and output ends in a polymer stack, onto an assembly substrate such that the polymer stack and the electro-optic modulation waveguides are adjacent to the assembly substrate and the substrate of the thin film polymer on substrate modulator is spaced away from the assembly substrate by the polymer stack;
mounting an input planar lightwave circuit die, the input planar lightwave circuit die including a plurality of input interface waveguides in a waveguide layer on a planar lightwave circuit substrate, onto the assembly substrate while aligning the plurality of input interface waveguides to the input ends of the electro-optic modulation waveguides of the thin film polymer on substrate such that the input planar lightwave circuit waveguide layer is adjacent to the assembly substrate and the planar lightwave circuit substrate is spaced away from the assembly substrate by the input planar lightwave circuit waveguide layer; and
mounting an output planar lightwave circuit die, the output planar lightwave circuit die including a plurality of output interface waveguides in a waveguide layer on a planar lightwave circuit substrate, onto the assembly substrate while aligning the plurality of output interface waveguides to the output ends of the electro-optic modulation waveguides of the thin film polymer on substrate modulator such that the output planar lightwave circuit waveguide layer is adjacent to the assembly substrate and the planar lightwave circuit substrate is spaced away from the assembly substrate by the output planar lightwave circuit waveguide layer.

50. The method for making a dual polarization quadrature light modulator of claim 49, wherein the input planar lightwave circuit die, the thin film polymer on substrate modulator die, and the output planar lightwave circuit die are mounted onto the assembly substrate by adhering the dice to the assembly substrate using an adhesive.

51. The method for making a dual polarization quadrature light modulator of claim 50, wherein the adhesive includes an optical adhesive.

52. The method for making a dual polarization quadrature light modulator of claim 50, further comprising:
curing the adhesive with ultraviolet light.

53. The method for making a dual polarization quadrature light modulator of claim 49, further comprising:
forming a groove in the output planar lightwave circuit die at a location corresponding to one or more waveguides configured to carry light after passing through a first portion of the electro-optic modulation waveguides; and
mounting a polarization rotator in the groove.

54. The method for making a dual polarization quadrature light modulator of claim 53, wherein forming the groove and mounting the polarization rotator is performed prior to mounting the output planar lightwave circuit die onto the assembly substrate.

55. The method for making a dual polarization quadrature light modulator of claim 49, wherein the output planar lightwave circuit die includes two output planar lightwave circuit dice; and further comprising:
mounting a polarization rotator between the two output planar lightwave circuit dice at a location corresponding to one or more waveguides configured to carry light after passing through a first portion of the electro-optic modulator waveguides.

56. The method for making a dual polarization quadrature light modulator of claim 49, further comprising:
before mounting the output planar lightwave circuit die onto the assembly substrate, mounting a polarization rotator adjacent to the output ends of a first portion of the electro-optic modulator waveguides; and
wherein mounting the output planar lightwave circuit die includes mounting the output planar lightwave circuit die adjacent to the polarization rotator.

57. The method for making a dual polarization quadrature light modulator of claim 56, further comprising:
before mounting the output planar lightwave circuit die onto the assembly substrate, mounting a non-polarization-rotating window having substantially the same thickness as the polarization rotator adjacent to the output ends of a second portion of the electro-optic modulator waveguides not subtended by the polarization rotator.

58. The method for making a dual polarization quadrature light modulator of claim 49, further comprising:
mounting the assembled assembly substrate, input planar lightwave circuit die, thin film polymer on substrate die, and output planar lightwave circuit die onto a mounting substrate such that the input planar lightwave circuit die, thin film polymer on substrate die, and output planar lightwave circuit die are adjacent to the mounting substrate and the assembly substrate is spaced away from the mounting substrate by the respective input planar lightwave circuit, thin film polymer on substrate, and output planar lightwave circuit substrates and waveguide layers.

59. The method for making a dual polarization quadrature light modulator of claim 58, wherein mounting the assembled assembly substrate, input planar lightwave circuit die, thin film polymer on substrate die, and output planar lightwave circuit die onto a mounting substrate includes placing a thermal gasket or thermal gel between the respective input planar lightwave circuit die, thin film polymer on substrate die, and output planar lightwave circuit die substrates and the mounting substrate.

60. The method for making a dual polarization quadrature light modulator of claim 49, wherein the assembly substrate includes a plurality of high speed electrodes corresponding to the electro-optic modulator waveguides; and
wherein mounting the thin film polymer on substrate die onto the assembly substrate includes aligning the electro-optic modulator waveguides to the high speed electrodes.

61. The method for making a dual polarization quadrature light modulator of claim 49, further comprising:
dicing the thin film polymer on substrate die from a thin film polymer on substrate wafer such that input and output facets of the electro-optic modulator waveguides are formed by a dicing saw.

62. The method for making a dual polarization quadrature light modulator of claim 49, further comprising:
forming the thin film polymer on substrate die from a thin film polymer on substrate wafer such that the input and output facets of the electro-optic modulator waveguides are formed by scoring the thin film polymer on substrate wafer and propagating a crack through the substrate and the thin film polymer.
